(19) United States
(12) Patent Application Publication
(10) Pub. No.: US 2026/0205947 A1
(43) Pub. Date: Jul. 16, 2026

(54) WAKING UP AN ENERGY-HARVESTING USER EQUIPMENT (UE) SUPPORTING MULTI-INTERFACE COMMUNICATIONS

(71) Applicant: QUALCOMM Incorporated, San Diego, CA (US)

(72) Inventors: Ahmed ELSHAFIE, San Diego, CA (US); Huilin XU, Temecula, CA (US); Linhai HE, San Diego, CA (US); Yuchul KIM, San Diego, CA (US); Seyedkianoush HOSSEINI, San Diego, CA (US); Wanshi CHEN, San Diego, CA (US); Zhikun WU, Beijing (CN); Peter GAAL, San Diego, CA (US); Prashant SHARMA, San Jose, CA (US)

(21) Appl. No.: 19/128,944

(22) PCT Filed: Feb. 1, 2023
(86) PCT No.: PCT/CN2023/074082

§ 371 Date: May 9, 2025

(51) Int. Cl. H04W 52/02; H04W 72/25

(52) U.S. Cl. CPC H04W 52/0235; H04W 72/25

(57) ABSTRACT

Methods, systems, and devices for waking up an energy-harvesting user equipment (UE) are described. The UE may receive, from a device such as a network entity or another UE, an indication of a configuration for a set of resources including multiple resource occasions for one or more wake-up request (WUR) messages and for one or more wake-up acknowledgement (WUA) messages. The configuration may be based on an energy profile of the UE. The UE may receive a WUR message during a first resource occasion of the multiple resource occasions in accordance with the configuration, and transmit, in response to the WUR message, a WUA message during a corresponding second resource occasion of the multiple resource occasions in accordance with the configuration.

### CROSS REFERENCE

The present Application is a 371 national phase filing of International PCT Application No. PCT/CN2023/074082 by ELSHAFIE et al., entitled “WAKING UP AN ENERGY-HAR VESTING USER EQUIPMENT (UE) SUPPORTING MULTI-INTERFACE COMMUNICATIONS,” filed Feb. 1, 2023, which is assigned to the assignee hereof, and which is expressly incorporated by reference in its entirety herein.

### FIELD OF TECHNOLOGY

The following relates to wireless communications, including waking up an energy-harvesting user equipment (UE) supporting multi-interface communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications devices may have energy harvesting capabilities, where devices may be able to harvest or otherwise obtain energy for device functions. For example, a UE that has relatively low power available may harvest energy to support ongoing communications.

### SUMMARY

The described techniques relate to improved methods, systems, devices, and apparatuses that support waking up an energy-harvesting user equipment (UE) supporting multi-interface communications. For example, the described techniques provide for a wireless protocol to schedule resources for wake-up signaling between an energy harvesting device, such as a UE, and another device such as a network entity or another UE. Some aspects more specifically relate to the transmission of wake-up requests (WUR) and for transmitting wake-up acknowledgements (WUA). For example, a device (e.g., a UE) may be configured with a set of dedicated periodic resources in a resource pool for receiving WUR and for transmitting WUA based on a past, current, or predicted future energy profile of the device. For example, the resource configuration for the WUR and WUA may be dynamically configured for the device based on a charging rate profile, a discharging rate profile (e.g., power or energy consumption), and the energy state profile of the device (or multiple devices, such as in the case of sidelink communications). The resources or resource pool may be configured such that when the energy harvesting device has sufficient power to receive a WUR and transmit a WUA, resources may be available. WUR and WUA occasions may be configured with relation to discontinuous reception (DRX) configurations and multiple interfaces.

A method for wireless communication at a UE is described. The method may include receiving an indication of a configuration for a set of resources including a set of multiple resource occasions for one or more WUR messages and for one or more WUA messages, the configuration being based on an energy profile of the UE, receiving a WUR message during a first resource occasion of the set of multiple resource occasions in accordance with the configuration, and transmitting, in response to the WUR message, a WUA message during a corresponding second resource occasion of the set of multiple resource occasions in accordance with the configuration.

An apparatus for wireless communication at a UE is described. The apparatus may include a processor, memory coupled with the processor, and instructions stored in the memory. The instructions may be executable by the processor to cause the apparatus to receive an indication of a configuration for a set of resources including a set of multiple resource occasions for one or more WUR messages and for one or more WUA messages, the configuration being based on an energy profile of the UE, receive a WUR message during a first resource occasion of the set of multiple resource occasions in accordance with the configuration, and transmit, in response to the WUR message, a WUA message during a corresponding second resource occasion of the set of multiple resource occasions in accordance with the configuration.

Another apparatus for wireless communication at a UE is described. The apparatus may include means for receiving an indication of a configuration for a set of resources including a set of multiple resource occasions for one or more WUR messages and for one or more WUA messages, the configuration being based on an energy profile of the UE, means for receiving a WUR message during a first resource occasion of the set of multiple resource occasions in accordance with the configuration, and means for transmitting, in response to the WUR message, a WUA message during a corresponding second resource occasion of the set of multiple resource occasions in accordance with the configuration.

A non-transitory computer-readable medium storing code for wireless communication at a UE is described. The code may include instructions executable by a processor to receive an indication of a configuration for a set of resources including a set of multiple resource occasions for one or more WUR messages and for one or more WUA messages, the configuration being based on an energy profile of the UE, receive a WUR message during a first resource occasion of the set of multiple resource occasions in accordance with the configuration, and transmit, in response to the WUR message, a WUA message during a corresponding second resource occasion of the set of multiple resource occasions in accordance with the configuration.

In some examples of the method, apparatuses, and non-transitory computer-readable medium described herein, the set of resources may be configured for at least two interfaces of the UE, and receiving the WUR message may include operations, features, means, or instructions for receiving the WUR message associated with a first interface of the at least two interfaces of the UE during a first resource occasion, where the at least two interfaces of the UE include one or more of a network-link interface, a sidelink interface, a Wi-Fi interface, a Bluetooth interface, or any other interface and waking up the first interface in accordance with the WUR message.

In some examples of the method, apparatuses, and non-transitory computer-readable medium described herein, the configuration includes a sidelink configuration and the set of resources include a set of sidelink resources and the method, apparatuses, and non-transitory computer-readable medium may include further operations, features, means, or instructions for monitoring for the WUR message during a first sidelink resource occasion of the set of sidelink resources in accordance with the configuration and transmitting, in response to the WUR message, the WUA message during a corresponding second sidelink resource occasion of the set of sidelink resources in accordance with the configuration.

Some examples of the method, apparatuses, and non-transitory computer-readable medium described herein may further include operations, features, means, or instructions for receiving a control message that indicates an adjustment to the configuration based on one or more changes in the energy profile of the UE.

In some examples of the method, apparatuses, and non-transitory computer-readable medium described herein, the configuration includes a sidelink configuration for one or more energy-harvesting UEs including the UE, and the set of resources include a set of sidelink resources for the one or more energy-harvesting UEs.

In some examples of the method, apparatuses, and non-transitory computer-readable medium described herein, the set of resources at least partially overlap with a set of sidelink feedback resources of a sidelink feedback channel having a same periodicity as the set of resources and the method, apparatuses, and non-transitory computer-readable medium may include further operations, features, means, or instructions for transmitting the WUA message via the set of resources based on the WUA message having a higher priority than the sidelink feedback channel, the set of resources having a greater number of resource blocks than the set of sidelink feedback resources, or both.

In some examples of the method, apparatuses, and non-transitory computer-readable medium described herein, a first resource corresponding to the first resource occasion for the WUR message may be at least partially linked to a second resource associated with the corresponding second resource occasion for the WUA message.

In some examples of the method, apparatuses, and non-transitory computer-readable medium described herein, transmitting the WUA message may include operations, features, means, or instructions for transmitting the WUA message based on a configured timing offset between receiving the WUR message and transmitting the WUA message.

In some examples of the method, apparatuses, and non-transitory computer-readable medium described herein, the configured timing offset may be based on the energy profile of the UE including energy harvesting capabilities or energy harvesting class of the UE, a charging rate profile, a discharging rate profile, an energy state profile, or any combination thereof.

In some examples of the method, apparatuses, and non-transitory computer-readable medium described herein, receiving the configuration may include operations, features, means, or instructions for identifying the first resource occasion corresponding to the WUR message and the corresponding second resource occasion corresponding to the WUA message based on a source identifier, a destination identifier, a scrambling identifier, a radio network temporary identifier (RNTI), a UE class, one or more synchronization signal block (SSB) indices used by the UE, one or more reference signals used by the UE, the energy profile of the UE, or any combination thereof.

In some examples of the method, apparatuses, and non-transitory computer-readable medium described herein, transmitting the WUA message may include operations, features, means, or instructions for transmitting, with the WUA message, an energy harvesting indication that indicates an extended amount of time the UE uses to perform energy harvesting.

In some examples of the method, apparatuses, and non-transitory computer-readable medium described herein, receiving the WUR message and transmitting the WUA message may include operations, features, means, or instructions for receiving one or more repetitions of the WUR message in accordance with a repetition factor during the first resource occasion of the set of multiple resource occasions in accordance with the configuration and transmitting one or more repetitions of the WUA message in accordance with the repetition factor during the corresponding second resource occasion of the set of multiple resource occasions in accordance with the configuration.

In some examples of the method, apparatuses, and non-transitory computer-readable medium described herein, the repetition factor may be based on a resource pool configuration, signaling between the UE and one or more sidelink UEs, an energy harvesting class of the UE, the energy profile of the UE including at least an energy state profile, a charging rate, or a discharging rate, an energy leakage rate of the UE, one or more energy profile thresholds, or any combination thereof.

Some examples of the method, apparatuses, and non-transitory computer-readable medium described herein may further include operations, features, means, or instructions for receiving the configuration via a network entity and determining, at the UE, the configuration as a subset of the set of resources.

In some examples of the method, apparatuses, and non-transitory computer-readable medium described herein, receiving the configuration may include operations, features, means, or instructions for selecting the set of resources based on a source identifier, a destination identifier, a scrambling identifier, an RNTI, a UE class, one or more SSB indices used by the UE, one or more reference signals used by the UE, the energy profile of the UE, a discontinuous reception (DRX) configuration, one or more UE identifiers, one or more energy harvesting identifiers, or any combination thereof.

In some examples of the method, apparatuses, and non-transitory computer-readable medium described herein, receiving the WUR message may include operations, features, means, or instructions for receiving the WUR message during the first resource occasion, the WUR message including a request for the UE to wake up a network-link interface, a sidelink interface, an interface X, an interface Y, or any combination thereof.

In some examples of the method, apparatuses, and non-transitory computer-readable medium described herein, the WUR message further includes a codepoint of bits instructing the UE to wake up the network-link interface, the sidelink interface, the interface X, the interface Y, or any combination thereof.

In some examples of the method, apparatuses, and non-transitory computer-readable medium described herein, transmitting the WUA message may include operations, features, means, or instructions for transmitting the WUA message during the corresponding second resource occasion, the WUA message including a capability indication of the UE to wake up a network-link interface, a sidelink interface, an interface X, an interface Y, or any combination thereof.

In some examples of the method, apparatuses, and non-transitory computer-readable medium described herein, transmitting the WUA message may include operations, features, means, or instructions for transmitting the WUA message during the corresponding second resource occasion, the WUA message including a capability indication of the UE to wake up a network-link interface after a first quantity of time units, a sidelink interface after a second quantity of time units, both the network-link interface and the sidelink interface after a third quantity of time units, or any combination thereof.

In some examples of the method, apparatuses, and non-transitory computer-readable medium described herein, transmitting the WUA message may include operations, features, means, or instructions for transmitting the WUA message including an engagement indication of a level of engagement the UE may have with a network-link interface, a sidelink interface, or both, based on the energy profile of the UE.

In some examples of the method, apparatuses, and non-transitory computer-readable medium described herein, the engagement indication includes one or more link monitoring capabilities of the UE, one or more data transmission modes, one or more reference signal monitoring modes, a threshold power configuration, one or more UE capability indications, or any combination thereof.

In some examples of the method, apparatuses, and non-transitory computer-readable medium described herein, transmitting the WUA message may include operations, features, means, or instructions for transmitting the WUA message via a network-link interface, where the network-link interface may be multiplexed with one or more uplink channels, one or more sidelink channels, one or more uplink reports, one or more sidelink reports, one or more layer signals, or any combination thereof.

In some examples of the method, apparatuses, and non-transitory computer-readable medium described herein, the WUR message and the WUA message may be separated or multiplexed with one or more sidelink resources, one or more uplink resources, one or more uplink reports, one or more sidelink reports, or any combination thereof.

Some examples of the method, apparatuses, and non-transitory computer-readable medium described herein may further include operations, features, means, or instructions for transmitting a capability indication of the UE to wake-up a network-link link via a sidelink message, to wake-up a sidelink via a network-link link message, or both.

In some examples of the method, apparatuses, and non-transitory computer-readable medium described herein, the energy profile of the UE includes a charging rate profile, a discharging rate profile, a power consumption rate profile, an energy state profile, or any combination thereof.

A method for wireless communication is described. The method may include transmitting an indication of a configuration for a set of resources including a set of multiple resource occasions for one or more WUR messages and for one or more WUA messages, the configuration being based on an energy profile of a UE, transmitting, to the UE, a WUR message during a first resource occasion of the set of multiple resource occasions in accordance with the configuration, and receiving, in response to the WUR message, a WUA message during a corresponding second resource occasion of the set of multiple resource occasions in accordance with the configuration.

An apparatus for wireless communication is described. The apparatus may include a processor, memory coupled with the processor, and instructions stored in the memory. The instructions may be executable by the processor to cause the apparatus to transmit an indication of a configuration for a set of resources including a set of multiple resource occasions for one or more WUR messages and for one or more WUA messages, the configuration being based on an energy profile of a UE, transmit, to the UE, a WUR message during a first resource occasion of the set of multiple resource occasions in accordance with the configuration, and receive, in response to the WUR message, a WUA message during a corresponding second resource occasion of the set of multiple resource occasions in accordance with the configuration.

Another apparatus for wireless communication is described. The apparatus may include means for transmitting an indication of a configuration for a set of resources including a set of multiple resource occasions for one or more WUR messages and for one or more WUA messages, the configuration being based on an energy profile of a UE, means for transmitting, to the UE, a WUR message during a first resource occasion of the set of multiple resource occasions in accordance with the configuration, and means for receiving, in response to the WUR message, a WUA message during a corresponding second resource occasion of the set of multiple resource occasions in accordance with the configuration.

A non-transitory computer-readable medium storing code for wireless communication is described. The code may include instructions executable by a processor to transmit an indication of a configuration for a set of resources including a set of multiple resource occasions for one or more WUR messages and for one or more WUA messages, the configuration being based on an energy profile of a UE, transmit, to the UE, a WUR message during a first resource occasion of the set of multiple resource occasions in accordance with the configuration, and receive, in response to the WUR message, a WUA message during a corresponding second resource occasion of the set of multiple resource occasions in accordance with the configuration.

Some examples of the method, apparatuses, and non-transitory computer-readable medium described herein may further include operations, features, means, or instructions for transmitting, to the UE, a control message that indicates an adjustment to the configuration based on one or more changes in the energy profile of the UE.

In some examples of the method, apparatuses, and non-transitory computer-readable medium described herein, the configuration includes a sidelink configuration for one or more energy-harvesting UEs including the UE, and the set of resources include a set of sidelink resources for the one or more energy-harvesting UEs.

### BRIEF DESCRIPTION OF THE DRAWINGS

FIGS. 1 and 2 illustrate examples of a wireless communications system that supports waking up an energy-harvesting user equipment (UE) supporting multi-interface communications in accordance with one or more aspects of the present disclosure.

FIGS. 3 and 4 illustrate examples of transmission timelines that support waking up an energy-harvesting UE supporting multi-interface communications in accordance with one or more aspects of the present disclosure.

FIG. 5 illustrates an example of a process flow that supports waking up an energy-harvesting UE supporting multi-interface communications in accordance with one or more aspects of the present disclosure.

FIGS. 6 and 7 illustrate block diagrams of devices that support waking up an energy-harvesting UE supporting multi-interface communications in accordance with one or more aspects of the present disclosure.

FIG. 8 illustrates a block diagram of a communications manager that supports waking up an energy-harvesting UE supporting multi-interface communications in accordance with one or more aspects of the present disclosure.

FIG. 9 illustrates a diagram of a system including a device that supports waking up an energy-harvesting UE supporting multi-interface communications in accordance with one or more aspects of the present disclosure.

FIGS. 10 and 11 illustrate block diagrams of devices that support waking up an energy-harvesting UE supporting multi-interface communications in accordance with one or more aspects of the present disclosure.

FIG. 12 illustrates a block diagram of an action response component that supports waking up an energy-harvesting UE supporting multi-interface communications in accordance with one or more aspects of the present disclosure.

FIG. 13 illustrates a diagram of a system including a device that supports waking up an energy-harvesting UE supporting multi-interface communications in accordance with one or more aspects of the present disclosure.

FIGS. 14 through 17 illustrate flowcharts showing methods that support waking up an energy-harvesting UE supporting multi-interface communications in accordance with one or more aspects of the present disclosure.

### DETAILED DESCRIPTION

Various aspects relate generally to wireless communications devices that may have energy harvesting capabilities which allow the devices to harvest or accumulate energy via various sources (e.g., via solar, thermal, vibrational, radio frequency (RF), etc.). For example, if an energy harvesting device has an insufficient amount of energy stores or battery power that falls below a threshold, the device may accumulate energy via energy harvesting in order to communicate with the network or other devices in the network. In some cases, however, energy harvesting resource availability and energy harvesting rates may be unpredictable or inconsistent, which may reduce communications quality and reliability between the energy harvesting device and the network. In addition, the energy harvesting device may be unreachable by the network while performing energy harvesting, which may further reduce communications quality and reliability. In addition, energy harvesting may occur at somewhat unpredictable or intermittent times, requiring coordinated wake-up signaling, which may cause further challenges for coordinating energy harvesting with established network or sidelink signaling.

Techniques described herein provide for establishing a wireless protocol to support reliable, coordinated communications between an energy-harvesting capable device and the network (e.g., or another UE) using scheduled resources for wake-up signaling. Some aspects more specifically relate to the transmission of wake-up requests (WUR) and for transmitting wake-up acknowledgements (WUA). For example, a device (e.g., a UE) may be configured with a set of dedicated periodic resources in a resource pool for WUR and for transmitting WUA based on a past, current, or predicted future energy profile of the device. The resources may be configured for one or more interfaces, and the resources or configurations may wake up one or more interfaces. For example, the resource configuration for the WUR and WUA may be dynamically configured for the device based on the charging rate profile, the discharging rate profile (e.g., power or energy consumption), and the energy state profile of the device (or multiple devices, such as in the case of sidelink communications). The resources may be configured such that when the energy harvesting device has sufficient power to receive a WUR and transmit a WUA, resources may be available. WUR and WUA occasions may be configured with relation to discontinuous reception (DRX) configurations and multiple interfaces of the UE.

Particular aspects of the subject matter described in this disclosure may be implemented to realize one or more of the following potential advantages. In some examples, by waking up an energy-harvesting UE according to the techniques described herein, the described techniques may result in reduced power consumption due to coordination of resources for WUR and WUA, meaning the UE spends less time searching for resources to receive WUR and transmit WUA. Additionally or alternatively, waking-up an energy harvesting UE according to the techniques described herein may support increased reliability of communications between the energy-harvesting UE and another device and increased quality of communications based on the UE having configured access to resources for energy harvesting and thus consistent support for energy harvesting, among other advantages.

Aspects of the disclosure are initially described in the context of wireless communications systems. Aspects of the disclosure are further illustrated by and described with reference to a wireless communications system, transmission timelines, and a process flow. Aspects of the disclosure are further illustrated by and described with reference to apparatus diagrams, system diagrams, and flowcharts that relate to waking up an energy-harvesting UE supporting multi-interface communications.

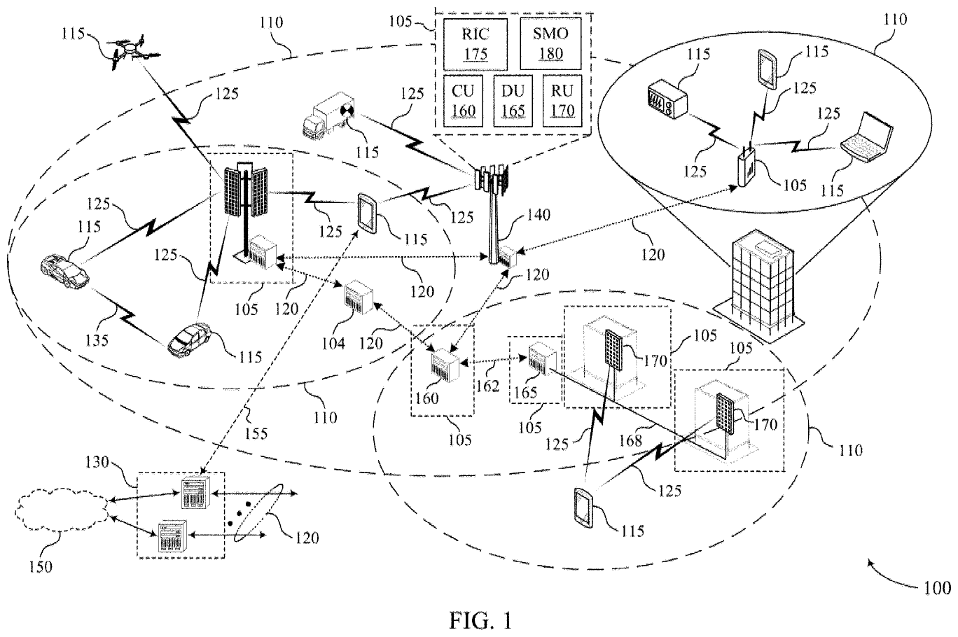

FIG. 1 illustrates an example of a wireless communications system 100 that supports waking up an energy-harvesting UE supporting multi-interface communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support waking up an energy-harvesting UE supporting multi-interface communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

Techniques described herein provide for establishing a wireless protocol to support reliable, coordinated communications between an energy-harvesting capable device, such as the UE 115, and the network or another UE 115 using scheduled resources for wake-up signaling. Some aspects more specifically relate to the transmission of WUR and for transmitting WUA. For example, the UE 115 may be configured with a set of dedicated periodic resources in a resource pool for receiving WUR and for transmitting WUA based on a past, current, or predicted future energy profile of the device. For example, the resource configuration for the WUR and WUA may be dynamically configured for the device based on the charging rate profile, the discharging rate profile (e.g., power or energy consumption), and the energy state profile of the device (or multiple devices, such as in the case of sidelink communications). The resources may be configured such that when the energy harvesting device has sufficient power to receive a WUR and to transmit a WUA, resources may be available. WUR and WUA occasions may be configured with relation to DRX configurations and multiple interfaces.

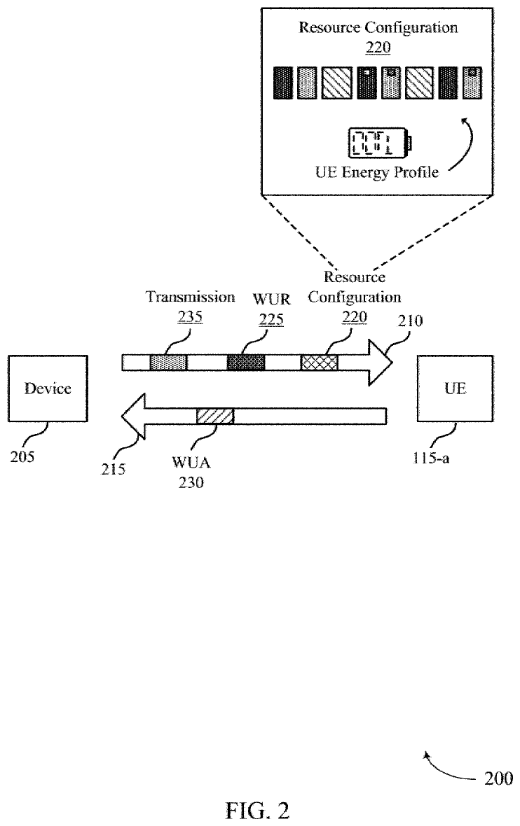

FIG. 2 illustrates an example of a wireless communications system 200 that supports waking up an energy-harvesting UE supporting multi-interface communications in accordance with one or more aspects of the present disclosure. The wireless communications system 200 describes the communications between a UE 115-a and another communications device 205. The communications device 205 may be a UE, a network entity, or another device.

The UE 115-a may connect to and communicate with the communications device 205 using communication links 210 and 215 (e.g., uplink communication links, downlink communication links). In some examples, the communication links 210 and 215 may be sidelinks, such as if the communications device 205 is another UE or group of UEs. The UE 115-a may be an example of the UE 115 as described with reference to FIG. 2. The communications device 205 may be an example of a network entity or another UE 115. The communications device 205 may transmit a resource configuration 220 to the UE 115-a, followed by a WUR 225. The UE 115-a may receive the WUR 225 and transmit a WUA 230 in response. The communications device 205 may respond with a transmission 235. In some examples, the WUR 225 may be referred to as a wake-up indication (WUI), and the WUA 230 may be referred to as a wake-up notification (WUN).

The UE 115-a may be an example of an energy harvesting powered device. An energy harvesting powered device may opportunistically harvest energy in the environment, such as solar, heat and ambient RF radiation and store the energy in a rechargeable battery. The techniques described herein may support operation on intermittently available energy harvested from the environment or other energy that may be available to the UE 115-a via energy harvesting resources. In some environments, variations in the amount of harvested energy, variations in network traffic, or both, may affect the amount of energy that the UE 115-a may harvest. For example, a device operating on intermittently available energy harvested from the environment may not sustain long continuous reception or transmission. In some examples, power consuming RF components such as analog-to-digital converter (ADC), mixers, oscillators, or any combination thereof may be used for energy harvesting powered devices.

The energy harvesting wireless device, such as the UE 115-a, may operate based on accumulated energy through an energy harvesting module (e.g., solar, thermal, vibration, RF). The communications device 205 may attempt to communicate with the UE 115-a. If the accumulated energy is not sufficient for the communication, the UE 115-a may accumulate additional energy. Until enough energy is accumulated, the UE 115-a may not be reachable from the communications device 205 (e.g., the network). In some examples, the communication quality between the energy harvesting wireless device (e.g., the UE 115-a) and communications device 205 (e.g., the network, a network entity, another UE) may be unpredictable or intermittent, which may be due at least in part to the somewhat unpredictable nature of energy harvesting availability and rate. The techniques described herein provide for a wireless protocol that may support reliable communication between the UE 115-a and the communications device 205 considering these aspects.

An energy harvesting device (e.g., the UE 115-a) may operate in duty cycled mode to save power (e.g., On and Off duration may be defined as DRX mode in LTE/NR). The network, or communications device 205, may not operate according to the assumption that the energy of the UE 115-a is available for data reception and transmission. If a transmission from the network is transmitted while the UE 115-a is an “off” state, such as due to low battery or energy, the transmission may be lost. The transmitting device, such as network entity or another UE, may save power by taking the status of the UE 115-a into account. The techniques described herein provide for a wireless protocol that may support reliable communication between the UE 115-a and the communications device 205 considering these aspects.

In some examples, wireless communications system 200 may support an energy handshake (EHS) mechanism, which may enable the communications device 205 to transmit and receive data with the energy harvesting UE 115-a when the energy harvesting UE 115-a has enough energy for communication (e.g., when the energy of the UE 115-a is above a threshold). The EHS mechanism may provide reliable communication between the communications device 205 (e.g., the network, a network entity, another UE) and the UE 115-a, and prevent the network from using radio resource unnecessarily. Signals for the EHS may include the WUR 225 and the WUA 230. The WUR 225 may be sent from the communications device 205 to request an indication from the UE 115-a indicating whether the UE 115-a has enough energy to wake up and receive data. The WUA 230 may be transmitted from the UE 115-a to the network entity to notify the communications device 205 of the energy of the UE 115-a, as well as possible action for the communications device 205 to take. The WUA 230 may indicate that the UE 115-a has enough energy for data reception or transmission and will wake up, or may indicate that the UE 115-a will continue to sleep and harvest energy until an indicated time duration (e.g., a time duration X).

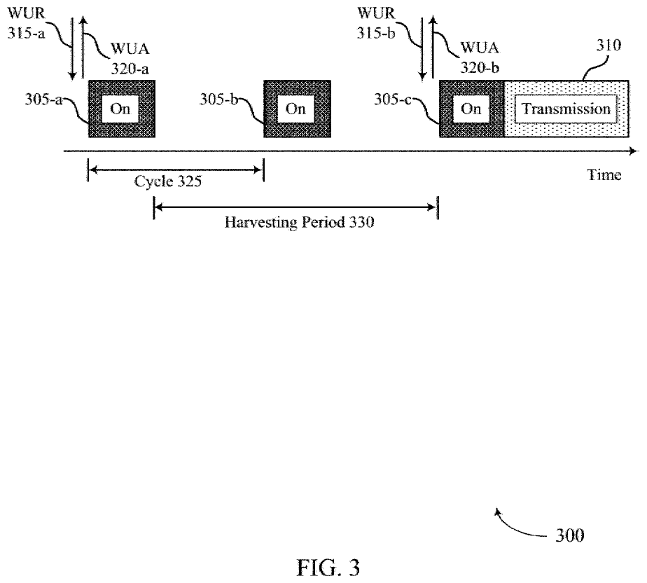

The EHS may be applied to duty cycled MAC operation. For example, the energy harvesting UE 115-a may be used with DRX operation with additional modification to the WUR 225 transmission timing and WUR 225 reception. The WUR 225 may be sent and received before an On duration during which a larger amount of data may be transmitted than during an Off duration. The WUR 225 may be sent before the configured On duration to determine whether energy harvesting UE 115-a has enough energy to wake up and receive data. In some examples, the WUR 225 timing may be preconfigured between the communications device 205 (e.g., a network entity) and the UE 115-a. The energy harvesting UE 115-a may determine whether to receive or decode the WUR 225 based on the energy of the UE 115-a. For example, if the UE 115-a does not have enough energy accumulated for receiving or decoding the WUR 225, the UE 115-a may skip receiving or decoding the WUR 225. IN some examples, the UE 115-a may transmit, as part of the WUA 230, an indication that the UE 115-a will have enough energy for transmissions in the future. The EHS applied to duty cycled MAC operation may described in further detail with reference to FIG. 3.

In some examples, the UE 115-a may receive the resource configuration 220 that is configured based on a UE energy profile of the UE 115-a. For example, the resource configuration 220 may be configured to support a charging or discharging rate of the UE 115-a, a current or future battery status of the UE 115-a, or any other energy profile of the UE 115-a. In some examples, the resource configuration 220 may notify the UE 115-a of configured locations to receive the WUR 225 and to correspondingly transmit the WUA 230.

FIG. 3 illustrates an example of a transmission timeline 300 that supports waking up an energy-harvesting UE supporting multi-interface, among other links, communications in accordance with one or more aspects of the present disclosure. The transmission timeline 300 describes the transmissions between a device, such as a network entity or a UE, and an energy harvesting device, such as a UE 115 as described with reference to FIGS. 1 and 2. FIG. 3 describes how the EHS may be applied to duty cycled MAC operation, and how a UE may utilize the EHS along with configured resources in order to efficiently wake up to perform energy harvesting. The energy harvesting UE may be used with DRX operation with additional modification to the WUR 315 transmission timing and WUA 320 reception. The WUR 315 may be an example of the WUR 225, and the WUA 320 may be an example of the WUA 230, as described with reference to FIG. 3 and FIG. 2, respectively.

On duration 305-a, On duration 305-b, and On duration 305-c may be On durations 305 of a DRX cycle, defined by a cycle 325. The cycle 325 may be defined as the time from the start of one On duration 305 to the start of the next. A harvesting period 330 may be defined as the time during which the UE 115-a may harvest enough energy to receive a WUR 315 and transmit the WUA 320. As described with reference to FIG. 3, the harvesting period 330 is the time from the end of the On duration 305-a to the beginning of the On duration 305-c. In some examples, the harvesting period may include multiple cycles, depending on the energy requirements or energy profile of the UE and the energy available.

A device may transmit the WUR 315-a to the energy harvesting UE, and the UE may determine whether or not to transmit the WUA 320-a after receiving the WUR 315-a. In some examples, the UE may determine to skip sending the WUA 320-a (e.g., the UE will not transit the WUA 320-a). The UE may determine to refrain from transmitting the WUA 320-a if the UE has not accumulated enough energy or the UE is avoiding frequent wake-ups to save power. The UE may avoid frequent wake-ups in cases that the traffic is delay-tolerant traffic, and where less-frequent-wake-up and deferred-reception may increase UE power savings. In some examples, the UE may transmit the WUA 320-a to indicate to the network entity that the UE will wake up and be ready for data reception or transmission, or the UE will not wake up for the next harvesting period 330, or the next duration X (e.g., X sec, or X cycles) for further energy harvesting. For example, the UE may indicate to the device, via the WUA 320-a, that the UE will not transmit until the On duration 305-c, thus skipping the On duration 305-b. The device may not transmit a WUR at the On duration 305-b, according to the WUA 320-a received from the UE, which may result in reduced resource network use. The device may transmit the WUR 315-b at the On duration 305-c, at the end of the harvesting period, when the UE has enough energy to transmit the WUA 320-a as well as the transmission 310. The transmission 310 may be communications between the device and the UE.

The UE may have different charging states determined by charging status and energy level, and UE behavior may vary between each charging state. The charging states may include a fully charged state, a partially charged state, and a low charging state. The fully charged state may be a state where the UE is fully charged and may perform regular operation, such as PDCCH monitoring for downlink data reception and uplink transmission, as well as sending energy level notifications to the device (e.g., a network entity). In a DRX configuration, the UE may wake up during the DRX On duration 305 or may skip the DRX On duration 305 based on WUR 315 reception and decoding. A partially charged state may be a state where the UE energy store is partially charged. In a partially charged state, data communication between the network entity and the UE may not be not supported, but the UE may communicate with the network entity about the UE's charging status, charging time, and expected wake-up time, among other factors. For example, the UE may receive the WUR 315, skip monitoring the WUR 315, transmit the WUA 320, or skip sending the WUA 320, as well as skip DRX On durations 305. A low charging state is a state where the UE may not be reachable by the device due to low energy level. In a low charging state, the UE may not transmit or receive data, including not receiving the WUR 315 and not transmitting the WUA 320, as well as skipping DRX On durations 305. The UE may harvest energy in a low charging state, as well as other charging states.

In some examples, the UE may gain and lose charge according to the transmissions, such as the transmission 235 and the WUR 315 and the WUA 320. Before the On duration 305-a, the energy level may be in a low charging state where the UE does not transmit or receive, or may be in a partially charged state where the UE may communicate the WUR and WUA with the network entity. If the UE is in a low charging state, the UE may skip the WUA 320-a. If the UE is in a partially charged state, the UE may transmit the WUA 320-a indicating that the UE will not wake up for the next harvesting period 330, or the next duration X (e.g., X see, or X cycles) for further energy harvesting.

If the UE indicates that the UE will not wake up for two cycles 325, the UE may charge during the harvesting period 330. After the harvesting period 330, at the start of the On duration 305-c, the UE may be in a fully charged state, capable of full communication with the device. The UE may receive the WUR 315-b and transmit the WUA 320-b indicating the UE will receive and transmit one or more transmissions. The UE may use some energy during the WUA 320-b transmission and On duration 305-c, but remain in the fully charged state. During the transmission 310, the UE may discharge to a low charging state, unable to transmit or receive, and begin recharging. The transmission 310 may include data communication from the UE to the device and from the device to the UE.

The WUR 315 may have many components. The WUR 315 may indicate to the UE to wake up for data reception. In some examples, the WUR 315 may indicate the amount of data for the UE buffered in the network, the pathloss (e.g., the latest value) for the UE to use in uplink power allocation, and a DRX configuration indication active time and Off durations. The pathloss value may be used to improve the quality of uplink transmissions. The WUR 315 may include (e.g., contain, be multiplexed with) a set of reference signals to support the UE in determining the pathloss. In some examples, the UE may use the demodulation reference signal (DMRS) of synchronization signal block (SSB), primary synchronization signal (PSS), secondary synchronization signal (SSS), or physical broadcast channel (PBCH) to estimate pathloss.

The WUA 320 may indicate to the network that the UE may wake up in current cycle or indicate to the network that the UE may not wake up for the current cycle. The WUA 320 may indicate the number (e.g., maximum) transport blocks, or bits, based on a configured or defined default transport block size, that may be decoded by the device during this On cycle. In some examples, there may be a known cost of each transport block transmission or reception indicated by UE (e.g., cost of transmitting or receiving a unit of various channels, such as PUSCH, PUCCH, PDSCH, or PDCCH). In some examples, the WUA 320 may indicate an uplink buffer status report (BSR) and suggested transport block sizes. For example, uplink BRS may be a function of downlink BSR. For example, the UE may determine what energy remains after the downlink BSR, such as if the WUR 315 includes the downlink BSR, and then the UE may send a number of bits (e.g., a maximum). From an initial power (P₀), such as target power for a resource block, pathloss, bandwidth (e.g., number of resource blocks per OFDM symbol), maximum power for a single OFDM transmission (Pₘₐₓ) may be determined. To determine the Pₘₐₓ, a number of resource elements may be determined using various methods. For example, the number of resources elements may be 12*M*N, where M represents the number of resource blocks and N represents the number of OFDM symbols to send to a transport block, without taking DMRS into account. Total power to transmit a transport block may be defined as Pₘₐₓ*N. The transport block size may be used to determine allocation sizes or transmission MCS. That is, with 1 layer, the number of REs may be determined. The parameter N_{info} may be equal to the number of resource elements multiplied by the parameter spectral_eff, if N_{info} and spectral_eff are known. In some examples, the number of resource elements may be fixed, such as preconfigured or configured resources, including configured grants or dynamic grants. The MCS index (e.g., spectral_eff) may be determined based on other known pieces of information.

In some examples, the UE may use the WUA 320-a to indicate a fixed per-symbol power (e.g., regardless of pathloss). For example, the UE may transmit according to a Pₘₐₓ, where the Pₘₐₓ is based on the number of resource elements for transport block transmission the device (e.g., the network entity) has allocated. Given the energy status, the UE may determine the uplink BSR or number of transport blocks to send to the device. Such computations may be reused as needed. The WUA 320-a may indicate to the network the number of cycles 325 the UE may skip for energy accumulation (e.g., for performing harvesting). The device (e.g., the network) may use this information to avoid unnecessary data buffering or may use this information to inform other devices that the UE is not available or reachable for the defined cycles 325 (e.g., X seconds or cycles). The WUA 320 may include a DRX configuration, which may include On durations 305 and Off durations.

WUR and WUA signaling may be transmitted on dedicated (e.g., periodic) resources in a resource pool, where the periodicity may be configured based on a UE energy profile and may be intermittently changed based on layer indications (e.g., L1, L2, L3), RRC configuration, or both. For example, a network entity may adjust the WUR and WUA resource configuration based on charging rate profile, discharging rate profile, energy or power consumption, and energy state profile at devices. Such configured resources may allow a UE to integrate WUR and WUA occasions with energy harvesting periods in order to efficiently maintain sufficient power without potential inefficiencies introduced by WUR and WUA resources that are unknown to the UE.

In some examples, the UE may transmit the WUA 320 without receiving the WUR 315. For example, the UE may have data to transmit (e.g., in any of the interfaces), and may transmit the WUA 320 without receiving the WUR 315. The UE may transmit the WUA 320 using dedicated resources (e.g., PUCCH, sidelink, or other resources) or multiplex with an layer (e.g., L1/L2/L3) indication in any of the supported interfaces. The WUA 320 may include information as described herein with reference to the WUA 320, as well as indicated which interfaces of the supported interfaces has data to send based on the amount of data, the energy profile of the UE, priorities (e.g., L1 and L2 priorities), or quality of the traffic, among other conditions.

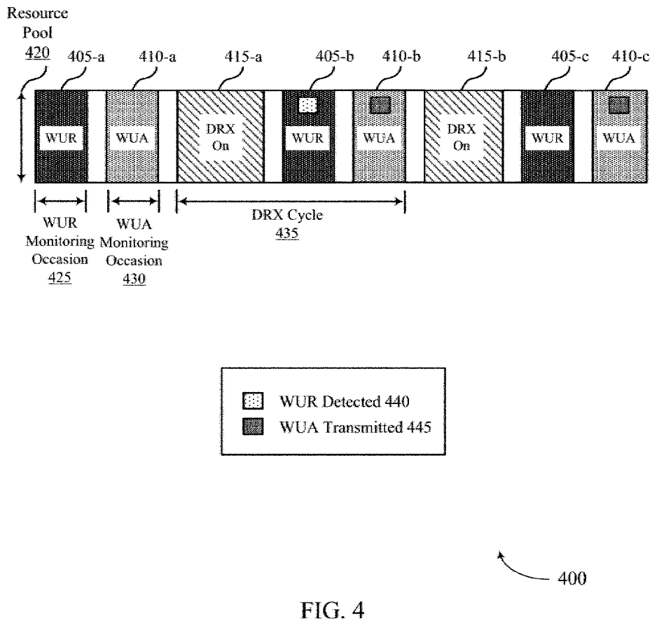

FIG. 4 illustrates an example of a transmission timeline 400 that supports waking up an energy-harvesting UE supporting multi-interface communications in accordance with one or more aspects of the present disclosure. The transmission timeline 400 describes communications between a device, such as the network or a UE, and an energy harvesting device, such as a UE. The communications may be network-link, between a network entity and a UE, or sidelink, between two UEs, or another link. The WUR 405 may be an example of the WUR 315 as described with reference to FIG. 3, a WUA 410 may be an example of the WUA 320 as described with reference to FIG. 3, and a DRX On 415 may be an example of the On duration 305 as described with reference to FIG. 3. FIG. 4 further describes the WUR 405 and the WUA 410, which may configure resources for the UE to communicate with other devices using various interfaces (e.g., Uu, LTE, Wi-Fi, Bluetooth, sidelink interfaces).

The resource pool 420 may include resources for WUR 405 reception, WUA 410 transmission, and DRX On 415 durations. The DRX cycle 435 may include a DRX On 415-a, a WUR 405, and a WUA 410. The DRX cycle 435 may repeat, such that the DRX 415-b, WUR 405-c, and WUA 410-c may be a DRX cycle 435. The WUR detected 440 indicates the resources used to transmit a WUR 405, such as in the case of the WUR 405-b. The WUA transmitted 445 may indicate the resources used to transmit a WUA 410, such as in the case of the WUA 410-b and the WUA 410-c. Not every WUR monitoring occasion 425 has a WUR detected 440, and not every WUA monitoring occasion 430 has a WUS transmitted 445. WUR 405 and WUA 410 transmission and detection may depend on the energy profile of the UE or the indications included in previous WUR 405 and WUA 410, among other factors.

WUR 405 and WUA 410 signals may be transmitted on dedicated (e.g., periodic) resources in a resource pool 420. In some examples, resources may be common across all resource pools and may be indicated to the UE. Resource periodicity may be configured for the resource pool 420, and may be changed based on layer indications (e.g., L1, L2, L3), RRC configuration between UE pairs, help from the network, a programmable logic controller (PLC), or a controlling UE or sidelink device. The DRX configuration may be based on the resource pool 420 or a combination of factors described herein. UEs may communicate using the same sidelink monitoring occasions for WUR 405 and WUA 410, such as the WUR monitoring occasion 425 and the WUA monitoring occasion 430. Configuration of the sidelink monitoring occasions may be configured during RRC connection, preconfigured (e.g., or loaded configuration), or a default at the beginning of communication. Layer signaling (e.g., L1, L2, and L3) may adjust the WUR 405 and WUA 410 resources configuration based on charging rate profile, discharging rate profile, energy or power consumption, and energy state profile at devices.

In some examples, a network entity may configure resources for each pair of UEs or a group of UEs to use, which may resemble mode 1 resource allocation. In some examples, a group of UEs may be a pair of UEs, or may be multiple UEs, where the UEs may be energy harvesting UEs of a configured transmission and reception class. The WUR 405, the WUA 410, or both, may overlap with physical sidelink feedback channel (PSFCH) or may be dedicated to other set of resources blocks with the same periodicity and at the same time. If resources are overlapped, the signal may be transmitted on the relatively bigger resource (e.g., the resource that spans the most amount of time) or the resource associated with the higher priority signal. For example, the WUR 405 and the WUA 410 may have higher priority than HARQ-ACK, and may have prioritized transmission over HARQ-ACK feedback transmissions. In some examples, the UE resource used by the receiving energy harvesting UE may be connected (e.g., linked) to the WUA 410 resource used by the transmitting UE, which may simplify the search for resources. The time offset between the WUR 405 and the WUA 410 may depend on the class of the energy harvesting UE, the current charging rate profile, the discharging rate profile, or the energy state profile at the devices. Resources may be configured based on energy harvesting, which may maintain a certain configuration of expected charging and discharging rates at the energy harvesting device (e.g., the UE).

Sidelink WUR and sidelink WUA may be sequence based and scrambled. WUR monitoring occasions 425 and WUA monitoring occasions 430 may be determined by a source ID, destination ID, configured scrambling ID, radio network temporary identifier (RNTI) configured by the two communicating UEs or group of communicating UEs, configured IDs (e.g., RNTI, scrambling IDs) configured by the network or configured by controlling UE PLC, or sidelink unit, the class of the communicating UEs (e.g., energy harvesting UE class), SSB index used by UEs, where a UE may transmit a SSB to another UE, and the other UE is able to identify the SSB; SSB indices used by UEs in Uu link from a network entity to or more UEs, if the indices are known at both UEs; other synchronization signal indices used between two UEs, reference signals used in previous communications and configured between UEs to be used as a way to determine the scrambling, discharging rate, charging rate, energy state of both UEs, or any combination thereof. A sidelink WUA may contain information, such as the harvesting time of the UE, such that resources of the sidelink WUA may be larger than the resources of the sidelink WUR.

WUR 405 and WUA 410 signaling may be repeated in frequency, which may increase reliability and save operation time for the energy harvesting receiving UE, thus saving energy. For example, the WUR 405-a and the WUA 410-a may repeat every DRX cycle 435, repeating at WUR 405-b and WUA 410-b. The frequency may have a repetition factor based on resource pool configuration configured by a network, network entity, controlling unit in sidelink or primary UE, or PLC or sidelink control unit; an agreement between the device (e.g., transmitting UE) and the energy harvest UE (e.g., receiving UE), using layers (e.g., L1, L2, L3), initial RRC communications, whether the device is also an energy harvesting device, the class of the device and the UE, the charging and discharging rate of the energy harvesting devices, the energy state profile of energy harvesting devices, the class of the device and the UE, or any combination thereof. Class may be associated with a threshold charging rate (e.g., maximum), a threshold discharging rate (e.g., minimum), discharging based on a clock, the On state of at least one or more components (e.g., radio frequency, hardware, software, and firmware), and storage leakage.

In some examples, a group of WUR 405 occasions and WUA 410 occasions may be determined for a pair of UEs. The occasions may be determined by various means. For example, the network may configure the WUR 405 and the WUA 410 occasions and resources, or the UEs may determine a subset or group of resources to use. The occasions may be randomly selected based on source ID, destination ID, configured scrambling ID, RNTI configured by the two communicating UEs or group of communicating UEs, configured IDs (e.g., RNTI, scrambling IDs) configured by the network or configured by controlling UE PLC, or sidelink unit, the class of the communicating UEs (e.g., energy harvesting UE class), SSB index used by UEs, where a UE may transmit a SSB to another UE, and the other UE is able to identify the SSB, SSB indices used by UEs in Uu link from a network entity to or more UEs, if the indices are known at both UEs; other synchronization signal indices used between two UEs, reference signals used in previous communications and configured between UEs to be used as a way to determine the scrambling, or discharging rate, charging rate, or energy state of both UEs, or any combination thereof. In some examples, the occasions may be based on a DRX configuration. The network entity may select a subset of occasions based on a combination of down-selected occasions of the UE. In response, the UE may further down-select, followed by selecting a set of resources blocks. The resource blocks may be used for communication, where the communication may be based on IDs of the UE, the device, or energy harvesting devices.

An energy harvesting device, such as the UE, may support sidelink, Uu link, as well as other links (e.g., LTE, Wi-Fi, Bluetooth, or another link). Monitoring for multiple wake-up signals (WUSs), such as a WUS for sidelink from a UE and a WUS from a network entity, may be power inefficient. Instead, a single indication, a WUR, may be transmitted from a sidelink UE, network entity, or another device to send a wake-up message to a UE. The UE may operate in 2 modes. In sidelink mode 1 resource allocation, the network entity assigns resource to UEs in sidelink and control scheduling. In mode 2 research allocation, or general sidelink operation, the network entity may use NR to control the communication to reduce power consumption at the UE.

In some examples, there may be a single monitoring occasion from each group of UEs and another WUS occasion from network entity. A monitoring occasion from each group of UEs may be enabled through coordination between the transmitting UEs (e.g., devices) and a receiving UE (e.g., the energy harvesting UE), such that the receiving UE may align DRX and WUS occasions of al UEs. In some other examples, there may be a single WUS monitoring occasion across all devices (or links, such as Uu and sidelink). For a single WUS monitoring occasion for all devices, the one or more transmitting UEs may coordinate with the network entity, and collectively send a single indication about wakeup. The UEs may transmit the indication of the WUR 405 from a single node for both links, and indication of UE response on waking up across the links.

In some examples, communications may be between a transmitting UE and an energy harvesting UE. The transmitting UE may send an indication about waking up the NR main radio (e.g., link, interface), the sidelink main radio (e.g., sidelink interface), or both. The WUR 405 may apply to multiple different interfaces, and wake up many different devices or functions. In some cases different resources may be configured for different interfaces of the UE.

The WUR 405 may wakeup any interface (e.g., NR, LTE, Wi-Fi, Bluetooth, or any other interface applicable to energy harvesting devices). For example, the WUR 405 may wake up a Uu main radio, a Uu interface, a Uu radio, a sidelink main radio, a sidelink interface, a sidelink radio, a wakeup interface X, a wakeup interface Y, or a combination thereof. In some examples, the WUR 405 may request an indication of which radios (e.g., sidelink, Uu) the UE supports. This may be useful in a scenario where the network entity and at least one sidelink UE may both have data for the UE, and the data are of the same priority (e.g., L1, L2). The indication of the UE radio may be a codepoint in a possible set of codepoints (e.g., 00 may indicate for the UE to indicate the link, 01 may indicate the UE may operate the Uu link, 10 may indicate the UE may operate sidelink, and 11 may indicate the UE may operate both Uu and sidelink), which may apply to other contexts and interfaces.

The WUA 410 may indicate the capability to wake up Uu only (e.g., main radio, interface, radio), sidelink only (e.g., main radio, interface, radio), interface X, interface Y, or a combination thereof. In some examples, the WUA 410 may indicate that the UE may wakeup both Uu main radio and sidelink main radio. The WUA 410 may indicate the capability to wakeup Uu main radio after various time units, such as DRX cycles. For example, the WUA 410 may indicate that the Uu main radio may wakeup after one time unit, indicating more harvesting is needed. In another example, the WUA 410 may indicate that the sidelink main radio may wakeup after two time units, indicating more harvesting is needed. The WUA 410 may indicate that the Uu and sidelink main radio may wakeup after three time units, indicating more harvesting is needed. In another example, the WUA 410 may indicate that the Uu main radio may wake up after one time unit, and the sidelink main radio make wake up after two time units after the first time unit. The WUA 410 may apply to other scenarios, interfaces, and time units.

The UE may use the WUA 410 to indicate the capability to be partially engaged with a link (e.g., interface) during a first time unit (e.g., X1) then fully engage after the second time unit (e.g., X2), based on charging and discharging rate and power expected power consumption during the first time unit, the second time unit, or both. The UE may indicate a mode (e.g., level) of engagement. In some examples, X1 and X2 may be provided by the UE from a table or codebook by configuration or may be selected from multiple values configured using various layers (e.g., L1, L2 or MAC-CE, L3 or RRC). In some examples, each mode may be associated RRC configuration, UE behavior, activation or deactivation of one or more layer channels and signals (e.g., L1 channels and signals, L2 channels and signals, L3 channels and signals), indication on the at least one or more of interfaces supported by the UE, or a combination thereof.

The UE and another device may operate according to modes of engagement defining the engagement of a link and the main purpose of each mode (e.g., level). The modes (e.g., levels) are defined in Table 1. In some examples, the engagement may be a combination of any mode or configuration. As part of the mode, power (e.g., maximum power) may configured. Additional factors of modes may include bandwidth, BLER, service (e.g., XR, URLLC, eMBB), RRC configuration, UE capability, separation between two consecutive signals, and limitation of aggregation levels (ALs), among other factors. Applicable ALs may include PDCCH, transport block size, allocated resource blocks for receiving, and allocated resource blocks for transmission. UE capability may include (eRedCap capability UE, RedCap capability UE, regular UE, new type of UE, very low power capability UE, or passive internet of things (IOT) UE, among other examples. Separation between two consecutive signals may include uplink to downlink, downlink to uplink, downlink to downlink, uplink to uplink, transmission sidelink to receiving sidelink, receiving sidelink to transmission sidelink, transmission to reception on interface X, or reception to transmission on interface X, among other examples.

TABLE 1
Modes of Link Engagement

| Mode | Purpose |
|---|---|
| Mode 1 | Dormant CC |
| Mode 2 | PDCCH monitoring only or a maximum number |
| | of PDCCH on certain time |
| Mode 3 | CSI-RS with certain number of ports and |
| | periodicities |
| Mode 4 | CSI-RS + SRS; Tx may be part of the limitation |
| Mode 5 | Data reception or data transmission only |
| Mode 6 | Data reception and transmission |
| Mode 7 | Data reception, SSB processing, CSI-RS |
| | processing |
| Mode 8 | Data reception, data transmission, CSI-RS |
| | processing, SRS transmission |
| Mode 9 | All capabilities of modes 1-9 |

The Uu interface of the WUA 410 may be separated uplink PUCCH resources or may be multiplexed with various signals (e.g., PUSCH, scheduling request, buffers status report (BSR), random access channel (RACH) messages, power headroom report (PHR), CSI report, any layer signal on an interface, a separate layer signal on an interface, or low power (LP) signal if the LP-WUR has a transmission side). The sidelink WUA and sidelink WUR may have separated PSFCH and sidelink resources and be multiplexed with various signals. The signals may include PSSCH, an uplink resource sidelink scheduling request to a network entity or UE using sidelink resources, a sidelink BSR to a network entity, a sidelink BSR to a UE, a sidelink power head room (PHR), a reference signal transmitted by the UE, a RACH message or an LP-signal (e.g., if the UE has LP-WUR that has a transmission side to send a WUA). The resources may be received as part of an LP-signal for sidelink WUA (e.g., LP-WUS, LP-RS, LP-SS). The UE may use any uplink signal in one link to indicate that the UE may wake up another link. For example, the UE may use dedicated PUCCH resources, one or more HARQ-ACK resources, one or more SR resources, BSR, PHR, one or more RACH messages, CSI, MAC-CE, RRC, multiplex with a sounding reference signal (SRS), or a combination thereof. The UE may multiplex with any layer signal on an interface, multiple with a separate layer signal on an interface, or use an LP signal (e.g., if the UE has LP-WUR with transmission capability).

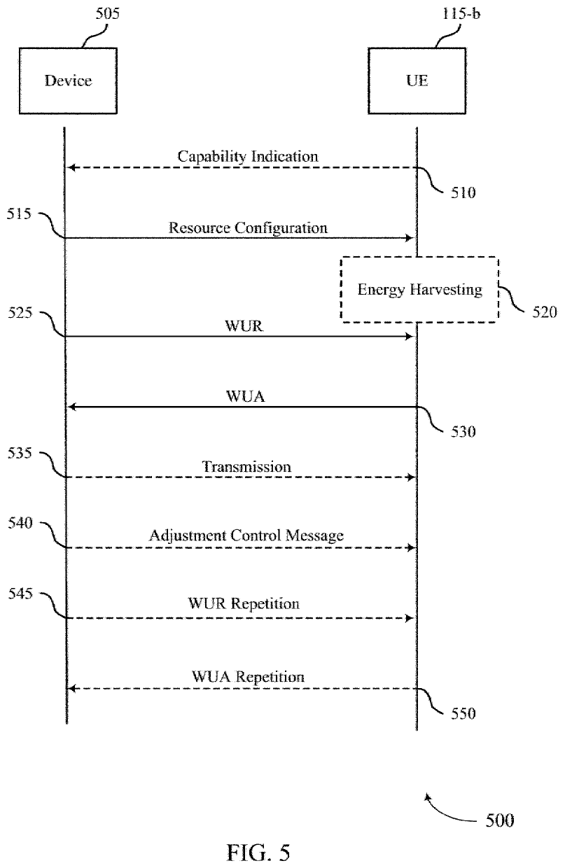

FIG. 5 illustrates an example of a process flow 500 that supports waking up an energy-harvesting UE supporting multi-interface communications in accordance with one or more aspects of the present disclosure. Process flow 500 describes the communications between a device 505, which may be an example of the communications device 205 as described with reference to FIG. 2, and the UE 115-b, which may be an example of the UE 115-a as described with reference to FIG. 2. The communications device 205 may be a UE, network entity, or other device. The UE 115-b may be an energy harvesting device. Alternative examples of the following process flow may be implemented, where some steps are performed in a different order than described or are not performed at all. In some cases, steps may include additional features not mentioned below, or further steps may be added.

Process flow diagram 500 may illustrate the transmission of WUR and WUA based on resource configuration for multiple interfaces. In the following description of the process flow 500, the operations between the UE 115-b and the device 505 may be performed in different orders or at different times. Some operations may also be left out of the process flow 500, or other operations may be added. Although the UE 115-b and the device 505 are shown performing the operations of the process flow 500, some aspects of some operations may also be performed by one or more other wireless devices.

At 510, the UE 115-b may transmit a capability indication to the device 505. The capability indication of the UE 115-b may indicate the capability of the UE 115-b to wake-up a network-link link via a sidelink message, to wake-up a sidelink via a network-link link message, or both

At 515, the UE 115-b may receive an indication of a configuration for a set of resources including multiple resource occasions for one or more WUR messages and for one or more WUA messages, the configuration being based on an energy profile of the UE 115-b. The configuration may configure the set of resources for at least two interfaces of the UE 115-b. In some examples, the configuration may include a sidelink configuration and the set of resources include a set of sidelink resources.

In some examples, the configuration may include a sidelink configuration for one or more energy-harvesting UEs including the UE 115-b, and the set of resources may include a set of sidelink resources for the one or more energy-harvesting UEs. A first resource corresponding to the first resource occasion for the WUR message may be at least partially linked to a second resource associated with the corresponding second resource occasion for the WUA message.

The UE 115-b may identify the first resource occasion corresponding to the WUR message and the corresponding second resource occasion corresponding to the WUA message based on a source ID, a destination ID, a scrambling ID, an RNTI, a UE class, one or more SSB indices used by the UE 115-b, one or more reference signals used by the UE, the energy profile of the UE 115-b, or any combination thereof. In some examples, the UE 115-b may receive the configuration via a network entity, or the UE 115-b may determine the configuration as a subset of the set of resources.

The UE 115-b may select the set of resources based on a source ID, a destination ID, a scrambling ID, an RNTI, a UE class, one or more SSB indices used by the UE 115-b, one or more reference signals used by the UE 115-b, the energy profile of the UE 115-b, a DRX configuration, one or more UE identifiers, one or more energy harvesting identifiers, or any combination thereof.

At 520, the UE 115-b may harvest energy. The energy profile of the UE 115-b may include a charging rate profile, a discharging rate profile, a power consumption rate profile, an energy state profile, or any combination thereof.

At 525, the UE 115-b may receive a WUR message during a first resource occasion of the multiple resource occasions in accordance with the configuration at 515. The set of resources may be configured for at least two interfaces of the UE 115-b, and receiving the WUR message may include receiving the WUR message associated with a first interface of the at least two interfaces of the UE 115-b during a first resource occasion. The at least two interfaces of the UE 115-b may include one or more of a network-link interface, a sidelink interface, a Wi-Fi interface, a Bluetooth interface, or any other interface. The UE 115-b may wake up the first interface in accordance with the WUR message.

In some examples, the configuration may include a sidelink configuration and the set of resources may include a set of sidelink resources, and the UE 115-b may monitor for the WUR message during a first sidelink resource occasion of the set of sidelink resources in accordance with the configuration.

The UE 115-b may receive the WUR message during the first resource occasion, the WUR message including a request for the UE to wake up a network-link interface, a sidelink interface, an interface X, an interface Y, or any combination thereof. The WUR message may also include a codepoint of bits instructing the UE 115-b to wake up the network-link interface, the sidelink interface, the interface X, the interface Y, or any combination thereof.

At 530, the UE 115-b may transmit, in response to the WUR message, a WUA message during a corresponding second resource occasion of the multiple resource occasions in accordance with the configuration. In some examples, such as if the configuration includes a sidelink configuration and the set of resources include a set of sidelink resources, the UE 115-b may transmit, in response to the WUR message, the WUA message during a corresponding second sidelink resource occasion of the set of sidelink resources in accordance with the configuration.

In some examples, the set of resources may at least partially overlap with a set of sidelink feedback resources of a sidelink feedback channel having a same periodicity as the set of resources, and the UE may transmit the WUA message via the set of resources based on the WUA message having a higher priority than the sidelink feedback channel, the set of resources having a greater number of resource blocks than the set of sidelink feedback resources, or both.

Transmitting the WUA may include transmitting the WUA message based on a configured timing offset between receiving the WUR message and transmitting the WUA message. The configured timing offset may be based on the energy profile of the UE 115-b, including energy harvesting capabilities or energy harvesting class of the UE, a charging rate profile, a discharging rate profile, an energy state profile, or any combination thereof. In some examples, transmitting the WUA may include transmitting, with the WUA message, an energy harvesting indication that indicates an extended amount of time the UE 115-b uses to perform energy harvesting.

The UE 115-b may transmit the WUA message during the corresponding second resource occasion, the WUA message including a capability indication of the UE to wake up a network-link interface, a sidelink interface, an interface X, an interface Y, or any combination thereof. The WUA message may include a capability indication of the UE 115-b to wake up a network-link interface after a first quantity of time units, a sidelink interface after a second quantity of time units, both the network-link interface and the sidelink interface after a third quantity of time units, or any combination thereof.

The WUA message may include an engagement indication of a level of engagement the UE 115-b has with a network-link interface, a sidelink interface, or both, based on the energy profile of the UE 115-b. The engagement indication may include one or more link monitoring capabilities of the UE 115-b, one or more data transmission modes, one or more reference signal monitoring modes, a threshold power configuration, one or more UE capability indications, or any combination thereof.

The WUA message may be transmitted via a network-link interface, where the network-link interface is multiplexed with one or more uplink channels, one or more sidelink channels, one or more uplink reports, one or more sidelink reports, one or more layer signals, or any combination thereof. In some examples, the WUR message and the WUA message may be separated or multiplexed with one or more sidelink resources, one or more uplink resources, one or more uplink reports, one or more sidelink reports, or any combination thereof.

At 535, the device 505 may transmit a transmission to the UE 115-b, and the UE 115-b may further communication with the device 505.

At 540, the UE 115-b may receive a control message that indicates an adjustment to the configuration based on one or more changes in the energy profile of the UE 115-b.

At 545, the UE 115-b may receive one or more repetitions of the WUR message in accordance with a repetition factor during the first resource occasion of the multiple resource occasions in accordance with the configuration. The repetition factor may be based on a resource pool configuration, signaling between the UE 115-b and one or more sidelink UEs, an energy harvesting class of the UE 115-b, the energy profile of the UE 115-b including at least an energy state profile, a charging rate, or a discharging rate, an energy leakage rate of the UE 115-b, one or more energy profile thresholds, or any combination thereof.

At 550, the UE 115-b may transmit one or more repetitions of the WUA message in accordance with the repetition factor during the corresponding second resource occasion of the multiple resource occasions in accordance with the configuration.

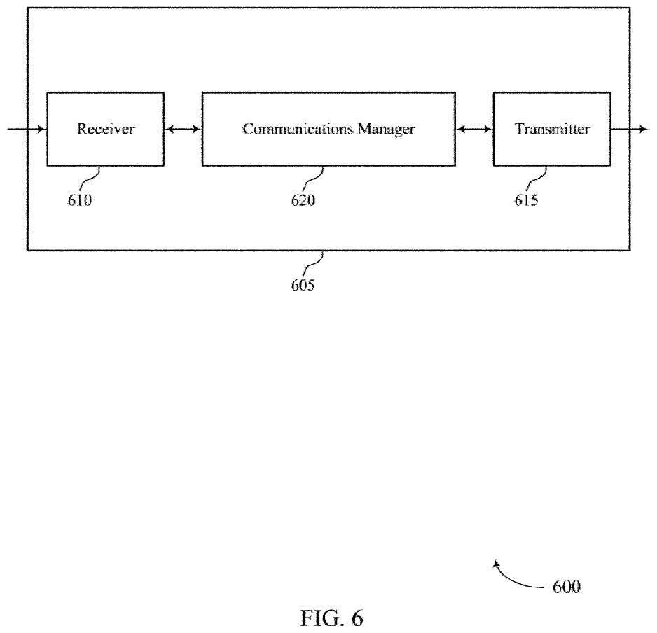

FIG. 6 illustrates a block diagram 600 of a device 605 that supports waking up an energy-harvesting UE supporting multi-interface communications in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to waking up an energy-harvesting UE supporting multi-interface communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to waking up an energy-harvesting UE supporting multi-interface communications). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of waking up an energy-harvesting UE supporting multi-interface communications as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for receiving an indication of a configuration for a set of resources including a set of multiple resource occasions for one or more WUR messages and for one or more WUA messages, the configuration being based on an energy profile of the UE. The communications manager 620 may be configured as or otherwise support a means for receiving a WUR message during a first resource occasion of the set of multiple resource occasions in accordance with the configuration. The communications manager 620 may be configured as or otherwise support a means for transmitting, in response to the WUR message, a WUA message during a corresponding second resource occasion of the set of multiple resource occasions in accordance with the configuration.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for waking up an energy-harvesting UE supporting multi-interface communications, which may result in reduced processing, reduced power consumption, or more efficient utilization of communication resources, among other advantages.

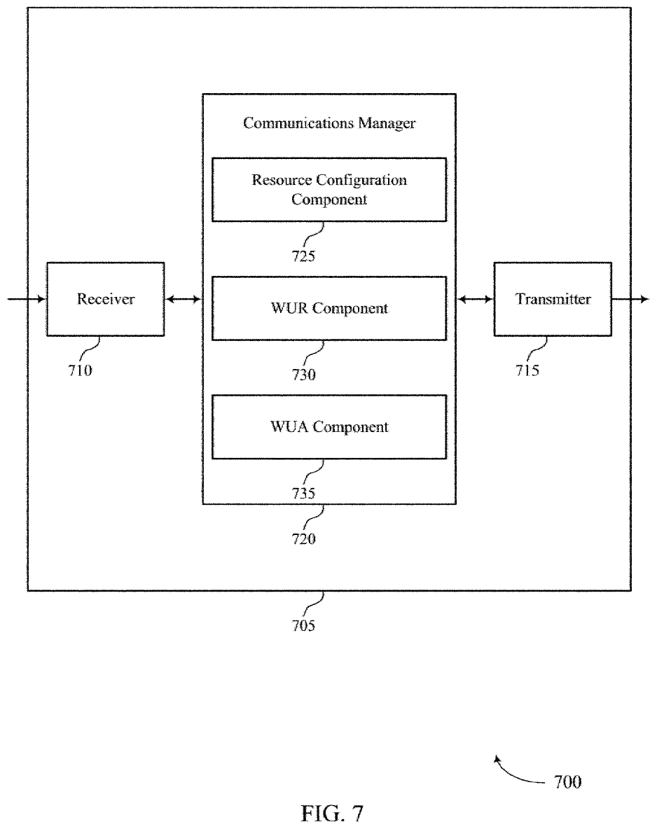

FIG. 7 illustrates a block diagram 700 of a device 705 that supports waking up an energy-harvesting UE supporting multi-interface communications in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to waking up an energy-harvesting UE supporting multi-interface communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to waking up an energy-harvesting UE supporting multi-interface communications). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of waking up an energy-harvesting UE supporting multi-interface communications as described herein. For example, the communications manager 720 may include a resource configuration component 725, a WUR component 730, a WUA component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The resource configuration component 725 may be configured as or otherwise support a means for receiving an indication of a configuration for a set of resources including a set of multiple resource occasions for one or more WUR messages and for one or more WUA messages, the configuration being based on an energy profile of the UE. The WUR component 730 may be configured as or otherwise support a means for receiving a WUR message during a first resource occasion of the set of multiple resource occasions in accordance with the configuration. The WUA component 735 may be configured as or otherwise support a means for transmitting, in response to the WUR message, a WUA message during a corresponding second resource occasion of the set of multiple resource occasions in accordance with the configuration.

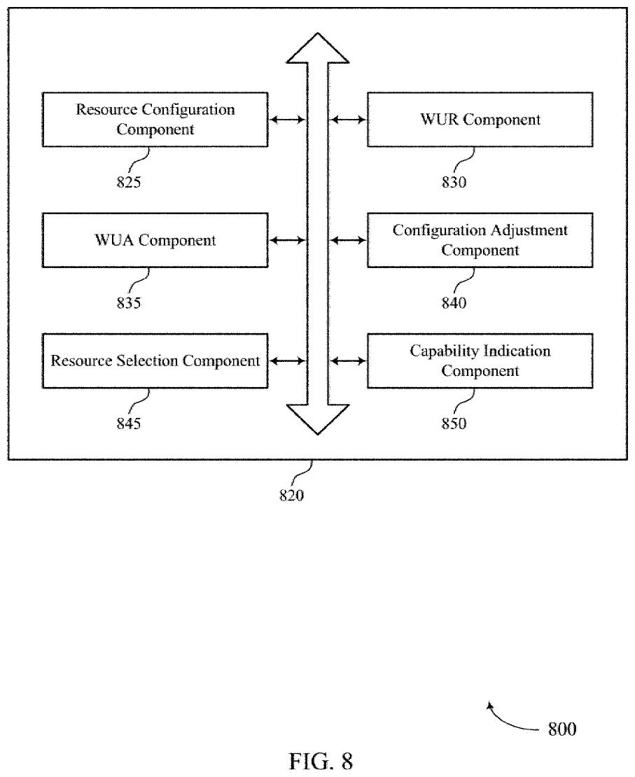

FIG. 8 illustrates a block diagram 800 of a communications manager 820 that supports waking up an energy-harvesting UE supporting multi-interface communications in accordance with one or more aspects of the present disclosure. The communications manager 820 may be an example of aspects of a communications manager 620, a communications manager 720, or both, as described herein. The communications manager 820, or various components thereof, may be an example of means for performing various aspects of waking up an energy-harvesting UE supporting multi-interface communications as described herein. For example, the communications manager 820 may include a resource configuration component 825, a WUR component 830, a WUA component 835, a configuration adjustment component 840, a resource selection component 845, a capability indication component 850, or any combination thereof. Each of these components may communicate, directly or indirectly, with one another (e.g., via one or more buses).

The communications manager 820 may support wireless communication at a UE in accordance with examples as disclosed herein. The resource configuration component 825 may be configured as or otherwise support a means for receiving an indication of a configuration for a set of resources including a set of multiple resource occasions for one or more WUR messages and for one or more WUA messages, the configuration being based on an energy profile of the UE. The WUR component 830 may be configured as or otherwise support a means for receiving a WUR message during a first resource occasion of the set of multiple resource occasions in accordance with the configuration. The WUA component 835 may be configured as or otherwise support a means for transmitting, in response to the WUR message, a WUA message during a corresponding second resource occasion of the set of multiple resource occasions in accordance with the configuration.

In some examples, the set of resources are configured for at least two interfaces of the UE and, to support receiving the WUR message, the WUA component 835 may be configured as or otherwise support a means for receiving the WUR message associated with a first interface of the at least two interfaces of the UE during a first resource occasion, where the at least two interfaces of the UE include one or more of a network-link interface, a sidelink interface, a Wi-Fi interface, a Bluetooth interface, or any other interface. In some examples, the set of resources are configured for at least two interfaces of the UE and, to support receiving the WUR message, the WUA component 835 may be configured as or otherwise support a means for waking up the first interface in accordance with the WUR message.

In some examples, the configuration includes a sidelink configuration and the set of resources include a set of sidelink resources, and the resource configuration component 825 may be configured as or otherwise support a means for monitoring for the WUR message during a first sidelink resource occasion of the set of sidelink resources in accordance with the configuration. In some examples, the configuration includes a sidelink configuration and the set of resources include a set of sidelink resources, and the resource configuration component 825 may be configured as or otherwise support a means for transmitting, in response to the WUR message, the WUA message during a corresponding second sidelink resource occasion of the set of sidelink resources in accordance with the configuration.

In some examples, the configuration adjustment component 840 may be configured as or otherwise support a means for receiving a control message that indicates an adjustment to the configuration based on one or more changes in the energy profile of the UE.

In some examples, the configuration includes a sidelink configuration for one or more energy-harvesting UEs including the UE, and the set of resources include a set of sidelink resources for the one or more energy-harvesting UEs.

In some examples, the set of resources at least partially overlap with a set of sidelink feedback resources of a sidelink feedback channel having a same periodicity as the set of resources, and the WUA component 835 may be configured as or otherwise support a means for transmitting the WUA message via the set of resources based on the WUA message having a higher priority than the sidelink feedback channel, the set of resources having a greater number of resource blocks than the set of sidelink feedback resources, or both.

In some examples, a first resource corresponding to the first resource occasion for the WUR message is at least partially linked to a second resource associated with the corresponding second resource occasion for the WUA message.

In some examples, to support transmitting the WUA message, the WUA component 835 may be configured as or otherwise support a means for transmitting the WUA message based on a configured timing offset between receiving the WUR message and transmitting the WUA message.

In some examples, the configured timing offset is based on the energy profile of the UE including energy harvesting capabilities or energy harvesting class of the UE, a charging rate profile, a discharging rate profile, an energy state profile, or any combination thereof.

In some examples, to support receiving the configuration, the resource configuration component 825 may be configured as or otherwise support a means for identifying the first resource occasion corresponding to the WUR message and the corresponding second resource occasion corresponding to the WUA message based on a source identifier, a destination identifier, a scrambling identifier, an RNTI, a UE class, one or more SSB indices used by the UE, one or more reference signals used by the UE, the energy profile of the UE, or any combination thereof.

In some examples, to support transmitting the WUA message, the WUA component 835 may be configured as or otherwise support a means for transmitting, with the WUA message, an energy harvesting indication that indicates an extended amount of time the UE uses to perform energy harvesting.

In some examples, to support receiving the WUR message and transmitting the WUA message, the WUR component 830 may be configured as or otherwise support a means for receiving one or more repetitions of the WUR message in accordance with a repetition factor during the first resource occasion of the set of multiple resource occasions in accordance with the configuration. In some examples, to support receiving the WUR message and transmitting the WUA message, the WUA component 835 may be configured as or otherwise support a means for transmitting one or more repetitions of the WUA message in accordance with the repetition factor during the corresponding second resource occasion of the set of multiple resource occasions in accordance with the configuration.

In some examples, the repetition factor is based on a resource pool configuration, signaling between the UE and one or more sidelink UEs, an energy harvesting class of the UE, the energy profile of the UE including at least an energy state profile, a charging rate, or a discharging rate, an energy leakage rate of the UE, one or more energy profile thresholds, or any combination thereof.

In some examples, the resource configuration component 825 may be configured as or otherwise support a means for receiving the configuration via a network entity. In some examples, the resource configuration component 825 may be configured as or otherwise support a means for determining, at the UE, the configuration as a subset of the set of resources.

In some examples, to support receiving the configuration, the resource selection component 845 may be configured as or otherwise support a means for selecting the set of resources based on a source identifier, a destination identifier, a scrambling identifier, an RNTI, a UE class, one or more SSB indices used by the UE, one or more reference signals used by the UE, the energy profile of the UE, a DRX configuration, one or more UE identifiers, one or more energy harvesting identifiers, or any combination thereof.

In some examples, to support receiving the WUR message, the WUR component 830 may be configured as or otherwise support a means for receiving the WUR message during the first resource occasion, the WUR message including a request for the UE to wake up a network-link interface, a sidelink interface, an interface X, an interface Y, or any combination thereof.

In some examples, the WUR message further includes a codepoint of bits instructing the UE to wake up the network-link interface, the sidelink interface, the interface X, the interface Y, or any combination thereof.

In some examples, to support transmitting the WUA message, the WUA component 835 may be configured as or otherwise support a means for transmitting the WUA message during the corresponding second resource occasion, the WUA message including a capability indication of the UE to wake up a network-link interface, a sidelink interface, an interface X, an interface Y, or any combination thereof.

In some examples, to support transmitting the WUA message, the WUA component 835 may be configured as or otherwise support a means for transmitting the WUA message during the corresponding second resource occasion, the WUA message including a capability indication of the UE to wake up a network-link interface after a first quantity of time units, a sidelink interface after a second quantity of time units, both the network-link interface and the sidelink interface after a third quantity of time units, or any combination thereof.

In some examples, to support transmitting the WUA message, the WUA component 835 may be configured as or otherwise support a means for transmitting the WUA message including an engagement indication of a level of engagement the UE has with a network-link interface, a sidelink interface, or both, based on the energy profile of the UE.

In some examples, the engagement indication includes one or more link monitoring capabilities of the UE, one or more data transmission modes, one or more reference signal monitoring modes, a threshold power configuration, one or more UE capability indications, or any combination thereof.

In some examples, to support transmitting the WUA message, the WUA component 835 may be configured as or otherwise support a means for transmitting the WUA message via a network-link interface, where the network-link interface is multiplexed with one or more uplink channels, one or more sidelink channels, one or more uplink reports, one or more sidelink reports, one or more layer signals, or any combination thereof.

In some examples, the WUR message and the WUA message are separated or multiplexed with one or more sidelink resources, one or more uplink resources, one or more uplink reports, one or more sidelink reports, or any combination thereof.

In some examples, the capability indication component 850 may be configured as or otherwise support a means for transmitting a capability indication of the UE to wake-up a network-link link via a sidelink message, to wake-up a sidelink via a network-link link message, or both.

In some examples, the energy profile of the UE includes a charging rate profile, a discharging rate profile, a power consumption rate profile, an energy state profile, or any combination thereof.

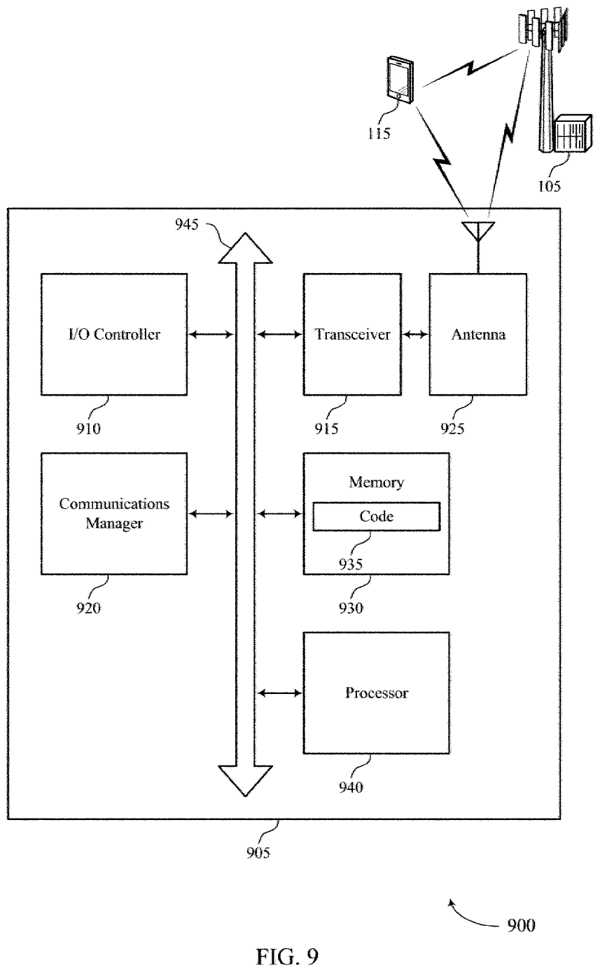

FIG. 9 illustrates a diagram of a system 900 including a device 905 that supports waking up an energy-harvesting UE supporting multi-interface communications in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting waking up an energy-harvesting UE supporting multi-interface communications). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving an indication of a configuration for a set of resources including a set of multiple resource occasions for one or more WUR messages and for one or more WUA messages, the configuration being based on an energy profile of the UE. The communications manager 920 may be configured as or otherwise support a means for receiving a WUR message during a first resource occasion of the set of multiple resource occasions in accordance with the configuration. The communications manager 920 may be configured as or otherwise support a means for transmitting, in response to the WUR message, a WUA message during a corresponding second resource occasion of the set of multiple resource occasions in accordance with the configuration.

By including or configuring the communications manager 920 in accordance with examples as described herein, the device 905 may support techniques for waking up an energy-harvesting UE supporting multi-interface communications, which may result in improved communication reliability, reduced latency, improved user experience related to reduced processing, reduced power consumption, more efficient utilization of communication resources, improved coordination between devices, longer battery life, or improved utilization of processing capability, among other advantages.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of waking up an energy-harvesting UE supporting multi-interface communications as described herein, or the processor 940 and the memory 930 may be otherwise configured to perform or support such operations.

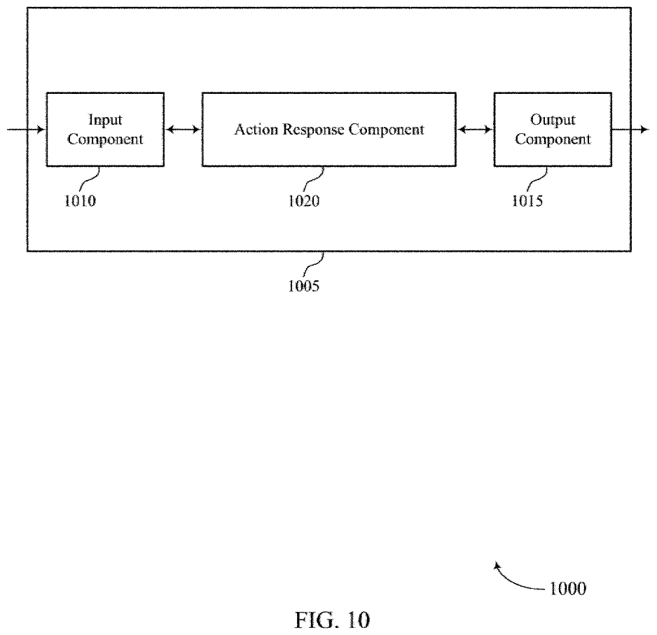

FIG. 10 illustrates a block diagram 1000 of a device 1005 that supports waking up an energy-harvesting UE supporting multi-interface communications in accordance with one or more aspects of the present disclosure. The device 1005 may be an example of aspects of a Generic Device as described herein. The device 1005 may include an input component 1010, an output component 1015, and an action response component 1020. The device 1005 may also include a processor. Each of these components may be in communication with one another (e.g., via one or more buses).

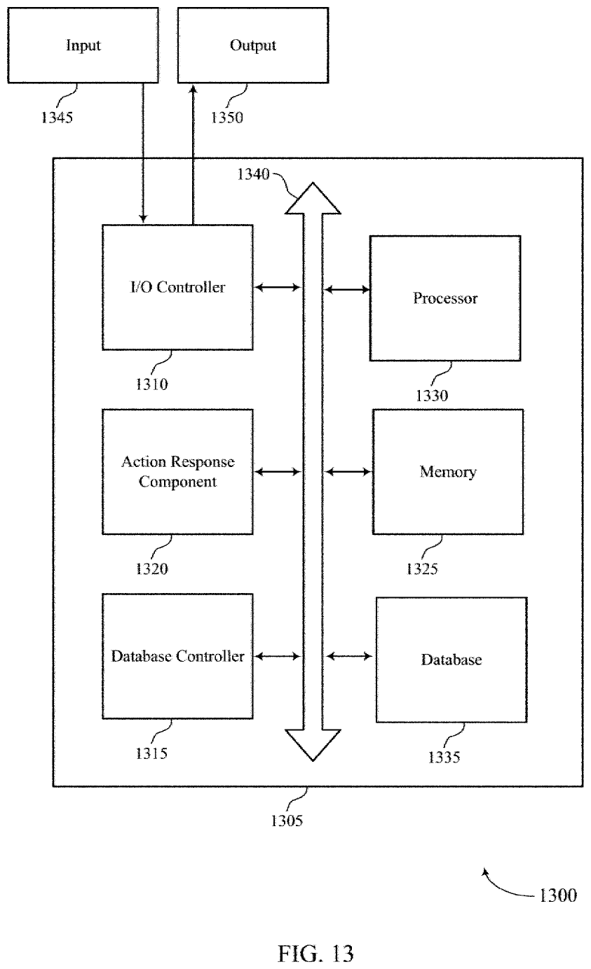

The input component 1010 may manage input signals for the device 1005. For example, the input component 1010 may identify input signals based on an interaction with a modem, a keyboard, a mouse, a touchscreen, or a similar device. These input signals may be associated with user input or processing at other components or devices. In some cases, the input component 1010 may utilize an operating system such as iOS®, ANDROID®, MS-DOS®, MS-WINDOWS®, OS/2®, UNIX®, LINUX®, or another known operating system to handle input signals. The input component 1010 may send aspects of these input signals to other components of the device 1005 for processing. For example, the input component 1010 may transmit input signals to the action response component 1020 to support waking up an energy-harvesting UE supporting multi-interface communications. In some cases, the input component 1010 may be a component of an I/O controller 1310 as described with reference to FIG. 13.

The output component 1015 may manage output signals for the device 1005. For example, the output component 1015 may receive signals from other components of the device 1005, such as the action response component 1020, and may transmit these signals to other components or devices. In some specific examples, the output component 1015 may transmit output signals for display in a user interface, for storage in a database or data store, for further processing at a server or server cluster, or for any other processes at any number of devices or systems. In some cases, the output component 1015 may be a component of an I/O controller 1310 as described with reference to FIG. 13.

The action response component 1020, the input component 1010, the output component 1015, or various combinations thereof or various components thereof may be examples of means for performing various aspects of waking up an energy-harvesting UE supporting multi-interface communications as described herein. For example, the action response component 1020, the input component 1010, the output component 1015, or various combinations or components thereof may support a method for performing one or more of the functions described herein.

In some examples, the action response component 1020, the input component 1010, the output component 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the action response component 1020, the input component 1010, the output component 1015, or various combinations or components thereof may be implemented in code (e.g., as communications management software or firmware) executed by a processor. If implemented in code executed by a processor, the functions of the action response component 1020, the input component 1010, the output component 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the action response component 1020 may be configured to perform various operations (e.g., receiving, obtaining, monitoring, outputting, transmitting) using or otherwise in cooperation with the input component 1010, the output component 1015, or both. For example, the action response component 1020 may receive information from the input component 1010, send information to the output component 1015, or be integrated in combination with the input component 1010, the output component 1015, or both to obtain information, output information, or perform various other operations as described herein.

The action response component 1020 may support wireless communication in accordance with examples as disclosed herein. For example, the action response component 1020 may be configured as or otherwise support a means for transmitting an indication of a configuration for a set of resources including a set of multiple resource occasions for one or more WUR messages and for one or more WUA messages, the configuration being based on an energy profile of a UE. The action response component 1020 may be configured as or otherwise support a means for transmitting, to the UE, a WUR message during a first resource occasion of the set of multiple resource occasions in accordance with the configuration. The action response component 1020 may be configured as or otherwise support a means for receiving, in response to the WUR message, a WUA message during a corresponding second resource occasion of the set of multiple resource occasions in accordance with the configuration.

By including or configuring the action response component 1020 in accordance with examples as described herein, the device 1005 (e.g., a processor controlling or otherwise coupled with the input component 1010, the output component 1015, the action response component 1020, or a combination thereof) may support techniques for waking up an energy-harvesting UE supporting multi-interface communications, which may result in reduced processing, reduced power consumption, or more efficient utilization of communication resources, among other advantages.

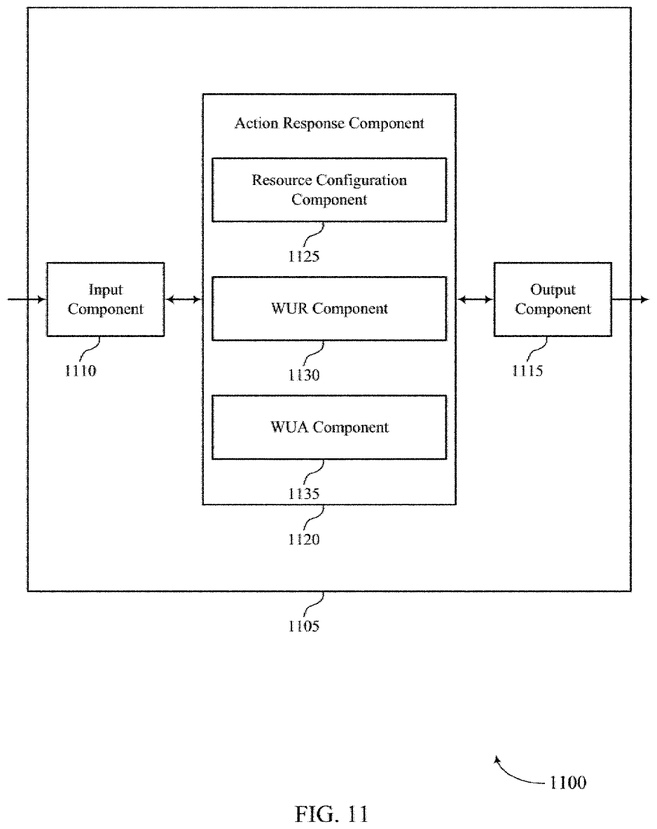

FIG. 11 illustrates a block diagram 1100 of a device 1105 that supports waking up an energy-harvesting UE supporting multi-interface communications in accordance with one or more aspects of the present disclosure. The device 1105 may be an example of aspects of a device 1005 or a Generic Device 115 as described herein. The device 1105 may include an input component 1110, an output component 1115, and an action response component 1120. The device 1105 may also include a processor. Each of these components may be in communication with one another (e.g., via one or more buses).

The input component 1110 may manage input signals for the device 1105. For example, the input component 1110 may identify input signals based on an interaction with a modem, a keyboard, a mouse, a touchscreen, or a similar device. These input signals may be associated with user input or processing at other components or devices. In some cases, the input component 1110 may utilize an operating system such as iOS®, ANDROID®, MS-DOS®, MS-WINDOWS®, OS/2®, UNIX®, LINUX®, or another known operating system to handle input signals. The input component 1110 may send aspects of these input signals to other components of the device 1105 for processing. For example, the input component 1110 may transmit input signals to the action response component 1120 to support waking up an energy-harvesting UE supporting multi-interface communications. In some cases, the input component 1110 may be a component of an I/O controller 1310 as described with reference to FIG. 13.

The output component 1115 may manage output signals for the device 1105. For example, the output component 1115 may receive signals from other components of the device 1105, such as the action response component 1120, and may transmit these signals to other components or devices. In some specific examples, the output component 1115 may transmit output signals for display in a user interface, for storage in a database or data store, for further processing at a server or server cluster, or for any other processes at any number of devices or systems. In some cases, the output component 1115 may be a component of an I/O controller 1310 as described with reference to FIG. 13.

The device 1105, or various components thereof, may be an example of means for performing various aspects of waking up an energy-harvesting UE supporting multi-interface communications as described herein. For example, the action response component 1120 may include a resource configuration component 1125, a WUR component 1130, a WUA component 1135, or any combination thereof. The action response component 1120 may be an example of aspects of an action response component 1020 as described herein. In some examples, the action response component 1120, or various components thereof, may be configured to perform various operations (e.g., receiving, obtaining, monitoring, outputting, transmitting) using or otherwise in cooperation with the input component 1110, the output component 1115, or both. For example, the action response component 1120 may receive information from the input component 1110, send information to the output component 1115, or be integrated in combination with the input component 1110, the output component 1115, or both to obtain information, output information, or perform various other operations as described herein.

The action response component 1120 may support wireless communication in accordance with examples as disclosed herein. The resource configuration component 1125 may be configured as or otherwise support a means for transmitting an indication of a configuration for a set of resources including a set of multiple resource occasions for one or more WUR messages and for one or more WUA messages, the configuration being based on an energy profile of a UE. The WUR component 1130 may be configured as or otherwise support a means for transmitting, to the UE, a WUR message during a first resource occasion of the set of multiple resource occasions in accordance with the configuration. The WUA component 1135 may be configured as or otherwise support a means for receiving, in response to the WUR message, a WUA message during a corresponding second resource occasion of the set of multiple resource occasions in accordance with the configuration.

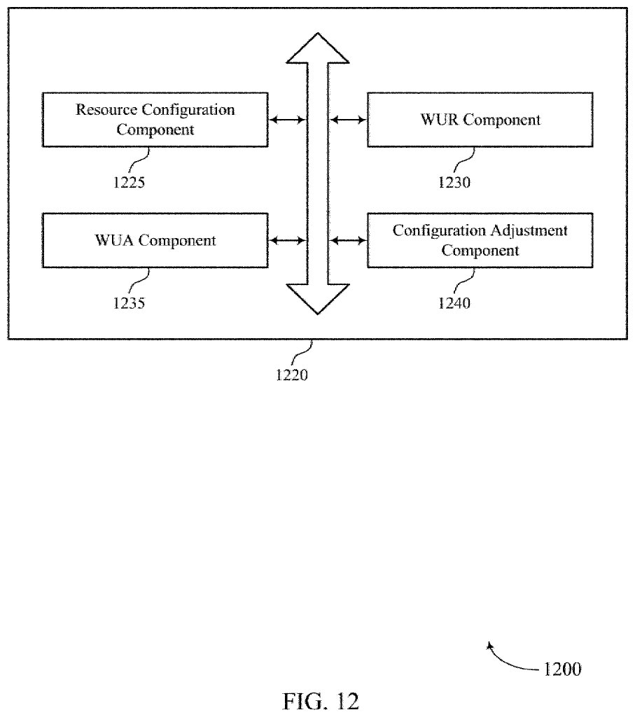

FIG. 12 illustrates a block diagram 1200 of an action response component 1220 that supports waking up an energy-harvesting UE supporting multi-interface communications in accordance with one or more aspects of the present disclosure. The action response component 1220 may be an example of aspects of an action response component 1020, an action response component 1120, or both, as described herein. The action response component 1220, or various components thereof, may be an example of means for performing various aspects of waking up an energy-harvesting UE supporting multi-interface communications as described herein. For example, the action response component 1220 may include a resource configuration component 1225, a WUR component 1230, a WUA component 1235, a configuration adjustment component 1240, or any combination thereof. Each of these components may communicate, directly or indirectly, with one another (e.g., via one or more buses).

The action response component 1220 may support wireless communication in accordance with examples as disclosed herein. The resource configuration component 1225 may be configured as or otherwise support a means for transmitting an indication of a configuration for a set of resources including a set of multiple resource occasions for one or more WUR messages and for one or more WUA messages, the configuration being based on an energy profile of a UE. The WUR component 1230 may be configured as or otherwise support a means for transmitting, to the UE, a WUR message during a first resource occasion of the set of multiple resource occasions in accordance with the configuration. The WUA component 1235 may be configured as or otherwise support a means for receiving, in response to the WUR message, a WUA message during a corresponding second resource occasion of the set of multiple resource occasions in accordance with the configuration.

In some examples, the configuration adjustment component 1240 may be configured as or otherwise support a means for transmitting, to the UE, a control message that indicates an adjustment to the configuration based on one or more changes in the energy profile of the UE.

In some examples, the configuration includes a sidelink configuration for one or more energy-harvesting UEs including the UE, and the set of resources include a set of sidelink resources for the one or more energy-harvesting UEs.

FIG. 13 illustrates a diagram of a system 1300 including a device 1305 that supports waking up an energy-harvesting UE supporting multi-interface communications in accordance with one or more aspects of the present disclosure. The device 1305 may be an example of or include the components of a device 1005, a device 1105, or a Generic Device as described herein. The device 1305 may include components for bi-directional voice and data communications including components for transmitting and receiving communications, such as an action response component 1320, an I/O controller 1310, a database controller 1315, a memory 1325, a processor 1330, and a database 1335. These components may be in electronic communication or otherwise coupled (e.g., operatively, communicatively, functionally, electronically, electrically) via one or more buses (e.g., a bus 1340).

The I/O controller 1310 may manage input signals 1345 and output signals 1350 for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally or alternatively, the I/O controller 1310 may represent or interact with a modem, a keyboard, a mouse, a touchscreen, or a similar device. In some cases, the I/O controller 1310 may be implemented as part of a processor. In some examples, a user may interact with the device 1305 via the I/O controller 1310 or via hardware components controlled by the I/O controller 1310.

The database controller 1315 may manage data storage and processing in a database 1335. The database 1335 may be external to the device 1305, temporarily or permanently connected to the device 1305, or a data storage component of the device 1305. In some cases, a user may interact with the database controller 1315. In some other cases, the database controller 1315 may operate automatically without user interaction. The database 1335 may be an example of a persistent data store, a single database, a distributed database, multiple distributed databases, a database management system, or an emergency backup database.

Memory 1325 may include random-access memory (RAM) and ROM. The memory 1325 may store computer-readable, computer-executable software including instructions that, when executed, cause the processor to perform various functions described herein. In some cases, the memory 1325 may contain, among other things, a BIOS which may control basic hardware or software operation such as the interaction with peripheral components or devices.

The processor 1330 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1330 may be configured to operate a memory array using a memory controller. In some other cases, a memory controller may be integrated into the processor 1330. The processor 1330 may be configured to execute computer-readable instructions stored in memory 1325 to perform various functions (e.g., functions or tasks supporting waking up an energy-harvesting UE supporting multi-interface communications).

The action response component 1320 may support wireless communication in accordance with examples as disclosed herein. For example, the action response component 1320 may be configured as or otherwise support a means for transmitting an indication of a configuration for a set of resources including a set of multiple resource occasions for one or more WUR messages and for one or more WUA messages, the configuration being based on an energy profile of a UE. The action response component 1320 may be configured as or otherwise support a means for transmitting, to the UE, a WUR message during a first resource occasion of the set of multiple resource occasions in accordance with the configuration. The action response component 1320 may be configured as or otherwise support a means for receiving, in response to the WUR message, a WUA message during a corresponding second resource occasion of the set of multiple resource occasions in accordance with the configuration.

By including or configuring the action response component 1320 in accordance with examples as described herein, the device 1305 may support techniques for waking up an energy-harvesting UE supporting multi-interface communications, which may result in improved communication reliability, reduced latency, improved user experience related to reduced processing, reduced power consumption, more efficient utilization of communication resources, improved coordination between devices, longer battery life, or improved utilization of processing capability, among other advantages.

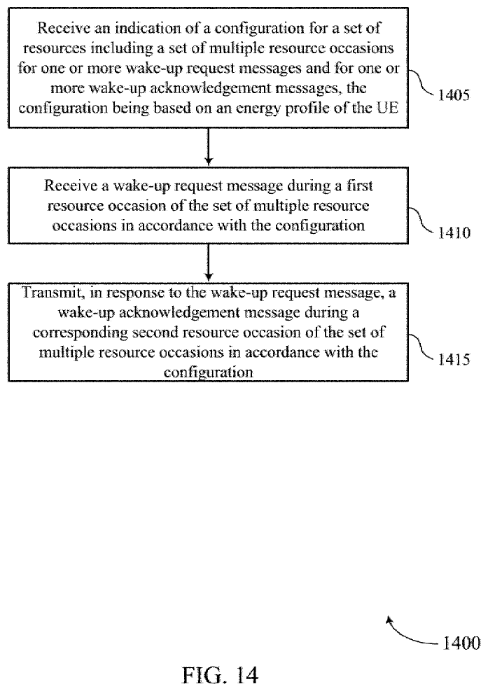

FIG. 14 illustrates a flowchart showing a method 1400 that supports waking up an energy-harvesting UE supporting multi-interface communications in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving an indication of a configuration for a set of resources including a set of multiple resource occasions for one or more WUR messages and for one or more WUA messages, the configuration being based on an energy profile of the UE. The operations of 1405 may be performed in accordance with examples as disclosed herein. In some examples, aspects of the operations of 1405 may be performed by a resource configuration component 825 as described with reference to FIG. 8.

At 1410, the method may include receiving a WUR message during a first resource occasion of the set of multiple resource occasions in accordance with the configuration. The operations of 1410 may be performed in accordance with examples as disclosed herein. In some examples, aspects of the operations of 1410 may be performed by a WUR component 830 as described with reference to FIG. 8.

At 1415, the method may include transmitting, in response to the WUR message, a WUA message during a corresponding second resource occasion of the set of multiple resource occasions in accordance with the configuration. The operations of 1415 may be performed in accordance with examples as disclosed herein. In some examples, aspects of the operations of 1415 may be performed by a WUA component 835 as described with reference to FIG. 8.

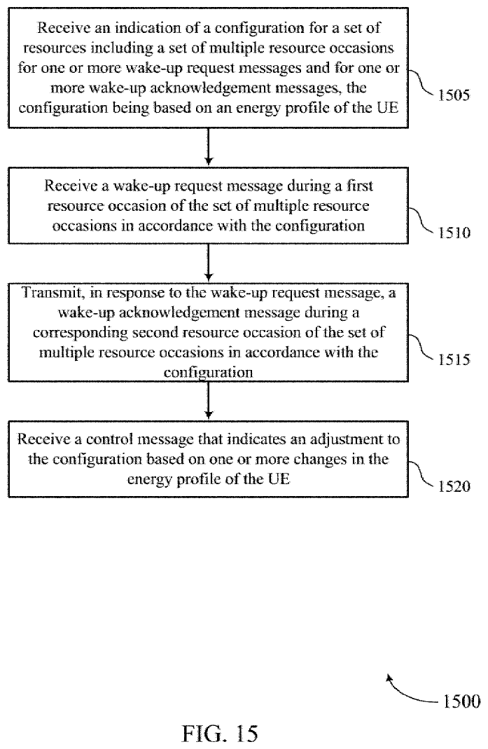

FIG. 15 illustrates a flowchart showing a method 1500 that supports waking up an energy-harvesting UE supporting multi-interface communications in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving an indication of a configuration for a set of resources including a set of multiple resource occasions for one or more WUR messages and for one or more WUA messages, the configuration being based on an energy profile of the UE. The operations of 1505 may be performed in accordance with examples as disclosed herein. In some examples, aspects of the operations of 1505 may be performed by a resource configuration component 825 as described with reference to FIG. 8.

At 1510, the method may include receiving a WUR message during a first resource occasion of the set of multiple resource occasions in accordance with the configuration. The operations of 1510 may be performed in accordance with examples as disclosed herein. In some examples, aspects of the operations of 1510 may be performed by a WUR component 830 as described with reference to FIG. 8.

At 1515, the method may include transmitting, in response to the WUR message, a WUA message during a corresponding second resource occasion of the set of multiple resource occasions in accordance with the configuration. The operations of 1515 may be performed in accordance with examples as disclosed herein. In some examples, aspects of the operations of 1515 may be performed by a WUA component 835 as described with reference to FIG. 8.

At 1520, the method may include receiving a control message that indicates an adjustment to the configuration based on one or more changes in the energy profile of the UE. The operations of 1520 may be performed in accordance with examples as disclosed herein. In some examples, aspects of the operations of 1520 may be performed by a configuration adjustment component 840 as described with reference to FIG. 8.

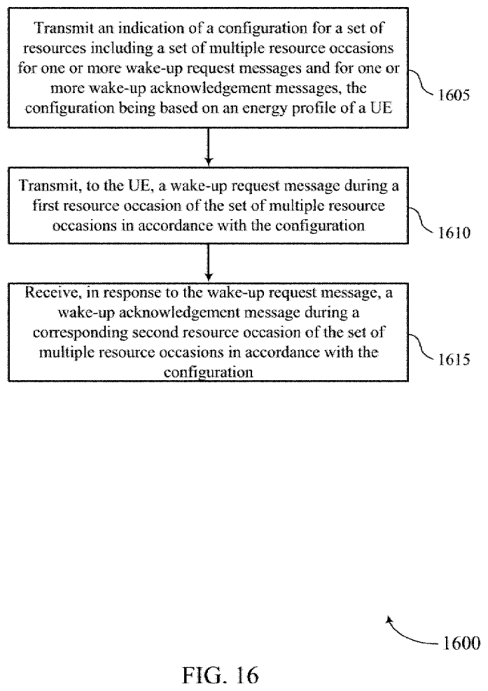

FIG. 16 illustrates a flowchart showing a method 1600 that supports waking up an energy-harvesting UE supporting multi-interface communications in accordance with one or more aspects of the present disclosure. The operations of the method 1600 may be implemented by a Generic Device or its components as described herein. For example, the operations of the method 1600 may be performed by a Generic Device as described with reference to FIGS. 1 through 5 and 10 through 13. In some examples, a Generic Device may execute a set of instructions to control the functional elements of the Generic Device to perform the described functions. Additionally, or alternatively, the Generic Device may perform aspects of the described functions using special-purpose hardware.

At 1605, the method may include transmitting an indication of a configuration for a set of resources including a set of multiple resource occasions for one or more WUR messages and for one or more WUA messages, the configuration being based on an energy profile of a UE. The operations of 1605 may be performed in accordance with examples as disclosed herein. In some examples, aspects of the operations of 1605 may be performed by a resource configuration component 1225 as described with reference to FIG. 12.

At 1610, the method may include transmitting, to the UE, a WUR message during a first resource occasion of the set of multiple resource occasions in accordance with the configuration. The operations of 1610 may be performed in accordance with examples as disclosed herein. In some examples, aspects of the operations of 1610 may be performed by a WUR component 1230 as described with reference to FIG. 12.

At 1615, the method may include receiving, in response to the WUR message, a WUA message during a corresponding second resource occasion of the set of multiple resource occasions in accordance with the configuration. The operations of 1615 may be performed in accordance with examples as disclosed herein. In some examples, aspects of the operations of 1615 may be performed by a WUA component 1235 as described with reference to FIG. 12.

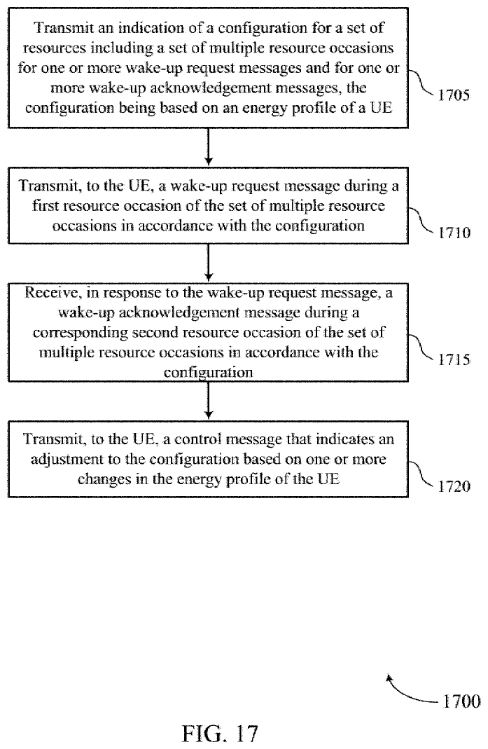

FIG. 17 illustrates a flowchart showing a method 1700 that supports waking up an energy-harvesting UE supporting multi-interface communications in accordance with one or more aspects of the present disclosure. The operations of the method 1700 may be implemented by a Generic Device or its components as described herein. For example, the operations of the method 1700 may be performed by a Generic Device as described with reference to FIGS. 1 through 5 and 10 through 13. In some examples, a Generic Device may execute a set of instructions to control the functional elements of the Generic Device to perform the described functions. Additionally, or alternatively, the Generic Device may perform aspects of the described functions using special-purpose hardware.

At 1705, the method may include transmitting an indication of a configuration for a set of resources including a set of multiple resource occasions for one or more WUR messages and for one or more WUA messages, the configuration being based on an energy profile of a UE. The operations of 1705 may be performed in accordance with examples as disclosed herein. In some examples, aspects of the operations of 1705 may be performed by a resource configuration component 1225 as described with reference to FIG. 12.

At 1710, the method may include transmitting, to the UE, a WUR message during a first resource occasion of the set of multiple resource occasions in accordance with the configuration. The operations of 1710 may be performed in accordance with examples as disclosed herein. In some examples, aspects of the operations of 1710 may be performed by a WUR component 1230 as described with reference to FIG. 12.

At 1715, the method may include receiving, in response to the WUR message, a WUA message during a corresponding second resource occasion of the set of multiple resource occasions in accordance with the configuration. The operations of 1715 may be performed in accordance with examples as disclosed herein. In some examples, aspects of the operations of 1715 may be performed by a WUA component 1235 as described with reference to FIG. 12.

At 1720, the method may include transmitting, to the UE, a control message that indicates an adjustment to the configuration based on one or more changes in the energy profile of the UE. The operations of 1720 may be performed in accordance with examples as disclosed herein. In some examples, aspects of the operations of 1720 may be performed by a configuration adjustment component 1240 as described with reference to FIG. 12.

The following provides an overview of aspects of the present disclosure:

Aspect 1: A method for wireless communication at a UE, comprising: receiving an indication of a configuration for a set of resources comprising a plurality of resource occasions for one or more WUR messages and for one or more WUA messages, the configuration being based at least in part on an energy profile of the UE; receiving a WUR message during a first resource occasion of the plurality of resource occasions in accordance with the configuration; and transmitting, in response to the WUR message, a WUA message during a corresponding second resource occasion of the plurality of resource occasions in accordance with the configuration.

Aspect 2: The method of aspect 1, wherein the set of resources are configured for at least two interfaces of the UE, and receiving the WUR message further comprises: receiving the WUR message associated with a first interface of the at least two interfaces of the UE during a first resource occasion, wherein the at least two interfaces of the UE comprise one or more of a network-link interface, a sidelink interface, a Wi-Fi interface, a Bluetooth interface, or any other interface; and waking up the first interface in accordance with the WUR message.

Aspect 3: The method of any of aspects 1 through 2, wherein the configuration comprises a sidelink configuration and the set of resources comprise a set of sidelink resources, the method further comprising: monitoring for the WUR message during a first sidelink resource occasion of the set of sidelink resources in accordance with the configuration; and transmitting, in response to the WUR message, the WUA message during a corresponding second sidelink resource occasion of the set of sidelink resources in accordance with the configuration.

Aspect 4: The method of any of aspects 1 through 3, further comprising: receiving a control message that indicates an adjustment to the configuration based at least in part on one or more changes in the energy profile of the UE.

Aspect 5: The method of any of aspects 1 through 4, wherein the configuration comprises a sidelink configuration for one or more energy-harvesting UEs including the UE, and the set of resources comprise a set of sidelink resources for the one or more energy-harvesting UEs.

Aspect 6: The method of any of aspects 1 through 5, wherein the set of resources at least partially overlap with a set of sidelink feedback resources of a sidelink feedback channel having a same periodicity as the set of resources, the method further comprising: transmitting the WUA message via the set of resources based at least in part on the WUA message having a higher priority than the sidelink feedback channel, the set of resources having a greater number of resource blocks than the set of sidelink feedback resources, or both.

Aspect 7: The method of any of aspects 1 through 6, wherein a first resource corresponding to the first resource occasion for the WUR message is at least partially linked to a second resource associated with the corresponding second resource occasion for the WUA message.

Aspect 8: The method of any of aspects 1 through 7, wherein transmitting the WUA message further comprises: transmitting the WUA message based at least in part on a configured timing offset between receiving the WUR message and transmitting the WUA message.

Aspect 9: The method of aspect 8, wherein the configured timing offset is based at least in part on the energy profile of the UE comprising energy harvesting capabilities or energy harvesting class of the UE, a charging rate profile, a discharging rate profile, an energy state profile, or any combination thereof.

Aspect 10: The method of any of aspects 1 through 9, wherein receiving the configuration further comprises: identifying the first resource occasion corresponding to the WUR message and the corresponding second resource occasion corresponding to the WUA message based at least in part on a source identifier, a destination identifier, a scrambling identifier, an RNTI, a UE class, one or more SSB indices used by the UE, one or more reference signals used by the UE, the energy profile of the UE, or any combination thereof.

Aspect 11: The method of any of aspects 1 through 10, wherein transmitting the WUA message further comprises: transmitting, with the WUA message, an energy harvesting indication that indicates an extended amount of time the UE uses to perform energy harvesting.

Aspect 12: The method of any of aspects 1 through 11, wherein receiving the WUR message and transmitting the WUA message further comprises: receiving one or more repetitions of the WUR message in accordance with a repetition factor during the first resource occasion of the plurality of resource occasions in accordance with the configuration; and transmitting one or more repetitions of the WUA message in accordance with the repetition factor during the corresponding second resource occasion of the plurality of resource occasions in accordance with the configuration.

Aspect 13: The method of aspect 12, wherein the repetition factor is based at least in part on a resource pool configuration, signaling between the UE and one or more sidelink UEs, an energy harvesting class of the UE, the energy profile of the UE including at least an energy state profile, a charging rate, or a discharging rate, an energy leakage rate of the UE, one or more energy profile thresholds, or any combination thereof.

Aspect 14: The method of any of aspects 1 through 13, further comprising: receiving the configuration via a network entity; or determining, at the UE, the configuration as a subset of the set of resources.

Aspect 15: The method of any of aspects 1 through 14, wherein receiving the configuration further comprises: selecting the set of resources based at least in part on a source identifier, a destination identifier, a scrambling identifier, an RNTI, a UE class, one or more SSB indices used by the UE, one or more reference signals used by the UE, the energy profile of the UE, a DRX configuration, one or more UE identifiers, one or more energy harvesting identifiers, or any combination thereof.

Aspect 16: The method of any of aspects 1 through 15, wherein receiving the WUR message further comprises: receiving the WUR message during the first resource occasion, the WUR message comprising a request for the UE to wake up a network-link interface, a sidelink interface, an interface X, an interface Y, or any combination thereof.

Aspect 17: The method of aspect 16, wherein the WUR message further comprises a codepoint of bits instructing the UE to wake up the network-link interface, the sidelink interface, the interface X, the interface Y, or any combination thereof.

Aspect 18: The method of any of aspects 1 through 17, wherein transmitting the WUA message further comprises: transmitting the WUA message during the corresponding second resource occasion, the WUA message comprising a capability indication of the UE to wake up a network-link interface, a sidelink interface, an interface X, an interface Y, or any combination thereof.

Aspect 19: The method of any of aspects 1 through 18, wherein transmitting the WUA message further comprises: transmitting the WUA message during the corresponding second resource occasion, the WUA message comprising a capability indication of the UE to wake up a network-link interface after a first quantity of time units, a sidelink interface after a second quantity of time units, both the network-link interface and the sidelink interface after a third quantity of time units, or any combination thereof.

Aspect 20: The method of any of aspects 1 through 19, wherein transmitting the WUA message further comprises: transmitting the WUA message comprising an engagement indication of a level of engagement the UE has with a network-link interface, a sidelink interface, or both, based at least in part on the energy profile of the UE.

Aspect 21: The method of aspect 20, wherein the engagement indication comprises one or more link monitoring capabilities of the UE, one or more data transmission modes, one or more reference signal monitoring modes, a threshold power configuration, one or more UE capability indications, or any combination thereof.

Aspect 22: The method of any of aspects 1 through 21, wherein transmitting the WUA message further comprises: transmitting the WUA message via a network-link interface, wherein the network-link interface is multiplexed with one or more uplink channels, one or more sidelink channels, one or more uplink reports, one or more sidelink reports, one or more layer signals, or any combination thereof.

Aspect 23: The method of any of aspects 1 through 22, wherein the WUR message and the WUA message are separated or multiplexed with one or more sidelink resources, one or more uplink resources, one or more uplink reports, one or more sidelink reports, or any combination thereof.

Aspect 24: The method of any of aspects 1 through 23, further comprising: transmitting a capability indication of the UE to wake-up a network-link link via a sidelink message, to wake-up a sidelink via a network-link link message, or both.

Aspect 25: The method of any of aspects 1 through 24, wherein the energy profile of the UE comprises a charging rate profile, a discharging rate profile, a power consumption rate profile, an energy state profile, or any combination thereof.

Aspect 26: A method for wireless communication, comprising: transmitting an indication of a configuration for a set of resources comprising a plurality of resource occasions for one or more WUR messages and for one or more WUA messages, the configuration being based at least in part on an energy profile of a UE; transmitting, to the UE, a WUR message during a first resource occasion of the plurality of resource occasions in accordance with the configuration; and receiving, in response to the WUR message, a WUA message during a corresponding second resource occasion of the plurality of resource occasions in accordance with the configuration.

Aspect 27: The method of aspect 26, further comprising: transmitting, to the UE, a control message that indicates an adjustment to the configuration based at least in part on one or more changes in the energy profile of the UE.

Aspect 28: The method of any of aspects 26 through 27, wherein the configuration comprises a sidelink configuration for one or more energy-harvesting UEs including the UE, and the set of resources comprise a set of sidelink resources for the one or more energy-harvesting UEs

Aspect 29: An apparatus for wireless communication at a UE, comprising a processor; memory coupled with the processor; and instructions stored in the memory and executable by the processor to cause the apparatus to perform a method of any of aspects 1 through 25.

Aspect 30: An apparatus for wireless communication at a UE, comprising at least one means for performing a method of any of aspects 1 through 25.

Aspect 31: A non-transitory computer-readable medium storing code for wireless communication at a UE, the code comprising instructions executable by a processor to perform a method of any of aspects 1 through 25.

Aspect 32: An apparatus for wireless communication, comprising a processor; memory coupled with the processor; and instructions stored in the memory and executable by the processor to cause the apparatus to perform a method of any of aspects 26 through 28.

Aspect 33: An apparatus for wireless communication, comprising at least one means for performing a method of any of aspects 26 through 28.

Aspect 34: A non-transitory computer-readable medium storing code for wireless communication, the code comprising instructions executable by a processor to perform a method of any of aspects 26 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
a processor;
memory coupled with the processor; and
instructions stored in the memory and executable by the processor to cause the apparatus to:
receive an indication of a configuration for a set of resources comprising a plurality of resource occasions for one or more wake-up request messages and for one or more wake-up acknowledgement messages, the configuration being based at least in part on an energy profile of the UE;
receive a wake-up request message during a first resource occasion of the plurality of resource occasions in accordance with the configuration; and
transmit, in response to the wake-up request message, a wake-up acknowledgement message during a corresponding second resource occasion of the plurality of resource occasions in accordance with the configuration.

2. The apparatus of claim 1, wherein the set of resources are configured for at least two interfaces of the UE, and the instructions to receive the wake-up request message are further executable by the processor to cause the apparatus to:
receive the wake-up request message associated with a first interface of the at least two interfaces of the UE during a first resource occasion, wherein the at least two interfaces of the UE comprise one or more of a network-link interface, a sidelink interface, a Wi-Fi interface, a Bluetooth interface, or any other interface; and
wake up the first interface in accordance with the wake-up request message.

3. The apparatus of claim 1, wherein the configuration comprises a sidelink configuration and the set of resources comprise a set of sidelink resources, and the instructions are further executable by the processor to cause the apparatus to:
monitor for the wake-up request message during a first sidelink resource occasion of the set of sidelink resources in accordance with the configuration; and
transmit, in response to the wake-up request message, the wake-up acknowledgement message during a corresponding second sidelink resource occasion of the set of sidelink resources in accordance with the configuration.

4. The apparatus of claim 1, wherein the instructions are further executable by the processor to cause the apparatus to:
receive a control message that indicates an adjustment to the configuration based at least in part on one or more changes in the energy profile of the UE.

5. The apparatus of claim 1, wherein the configuration comprises a sidelink configuration for one or more energy-harvesting UEs including the UE, and the set of resources comprise a set of sidelink resources for the one or more energy-harvesting UEs.

6. The apparatus of claim 1, wherein the set of resources at least partially overlap with a set of sidelink feedback resources of a sidelink feedback channel having a same periodicity as the set of resources, and the instructions are further executable by the processor to cause the apparatus to:
transmit the wake-up acknowledgement message via the set of resources based at least in part on the wake-up acknowledgement message having a higher priority than the sidelink feedback channel, the set of resources having a greater number of resource blocks than the set of sidelink feedback resources, or both.

7. The apparatus of claim 1, wherein a first resource corresponding to the first resource occasion for the wake-up request message is at least partially linked to a second resource associated with the corresponding second resource occasion for the wake-up acknowledgement message.

8. The apparatus of claim 1, wherein the instructions to transmit the wake-up acknowledgement message are further executable by the processor to cause the apparatus to:
transmit the wake-up acknowledgement message based at least in part on a configured timing offset between receiving the wake-up request message and transmitting the wake-up acknowledgement message.

9. (canceled)

10. The apparatus of claim 1, wherein the instructions to receive the configuration are further executable by the processor to cause the apparatus to:
identify the first resource occasion corresponding to the wake-up request message and the corresponding second resource occasion corresponding to the wake-up acknowledgement message based at least in part on a source identifier, a destination identifier, a scrambling identifier, a radio network temporary identifier, a UE class, one or more synchronization signal block indices used by the UE, one or more reference signals used by the UE, the energy profile of the UE, or any combination thereof.

11. The apparatus of claim 1, wherein the instructions to transmit the wake-up acknowledgement message are further executable by the processor to cause the apparatus to:
transmit, with the wake-up acknowledgement message, an energy harvesting indication that indicates an extended amount of time the UE uses to perform energy harvesting.

12. The apparatus of claim 1, wherein the instructions to receive the wake-up request message and transmitting the wake-up acknowledgement message are further executable by the processor to cause the apparatus to:
receive one or more repetitions of the wake-up request message in accordance with a repetition factor during the first resource occasion of the plurality of resource occasions in accordance with the configuration; and
transmit one or more repetitions of the wake-up acknowledgement message in accordance with the repetition factor during the corresponding second resource occasion of the plurality of resource occasions in accordance with the configuration.

13. (canceled)

14. The apparatus of claim 1, wherein the instructions are further executable by the processor to cause the apparatus to:
receive the configuration via a network entity; or
determine, at the UE, the configuration as a subset of the set of resources.

15. The apparatus of claim 1, wherein the instructions to receive the configuration are further executable by the processor to cause the apparatus to:
select the set of resources based at least in part on a source identifier, a destination identifier, a scrambling identifier, a radio network temporary identifier, a UE class, one or more synchronization signal block indices used by the UE, one or more reference signals used by the UE, the energy profile of the UE, a discontinuous reception configuration, one or more UE identifiers, one or more energy harvesting identifiers, or any combination thereof.

16. The apparatus of claim 1, wherein the instructions to receive the wake-up request message are further executable by the processor to cause the apparatus to:
receive the wake-up request message during the first resource occasion, the wake-up request message comprising a request for the UE to wake up a network-link interface, a sidelink interface, an interface X, an interface Y, or any combination thereof.

17. (canceled)

18. The apparatus of claim 1, wherein the instructions to transmit the wake-up acknowledgement message are further executable by the processor to cause the apparatus to:
transmit the wake-up acknowledgement message during the corresponding second resource occasion, the wake-up acknowledgement message comprising a capability indication of the UE to wake up a network-link interface, a sidelink interface, an interface X, an interface Y, or any combination thereof.

19. The apparatus of claim 1, wherein the instructions to transmit the wake-up acknowledgement message are further executable by the processor to cause the apparatus to:
transmit the wake-up acknowledgement message during the corresponding second resource occasion, the wake-up acknowledgement message comprising a capability indication of the UE to wake up a network-link interface after a first quantity of time units, a sidelink interface after a second quantity of time units, both the network-link interface and the sidelink interface after a third quantity of time units, or any combination thereof.

20. The apparatus of claim 1, wherein the instructions to transmit the wake-up acknowledgement message are further executable by the processor to cause the apparatus to:
transmit the wake-up acknowledgement message comprising an engagement indication of a level of engagement the UE has with a network-link interface, a sidelink interface, or both, based at least in part on the energy profile of the UE.

21-23. (canceled)

24. The apparatus of claim 1, wherein the instructions are further executable by the processor to cause the apparatus to:
transmit a capability indication of the UE to wake-up a network-link link via a sidelink message, to wake-up a sidelink via a network-link link message, or both.

25. (canceled)

26. An apparatus for wireless communication, comprising:
a processor;
memory coupled with the processor; and
instructions stored in the memory and executable by the processor to cause the apparatus to:
transmit an indication of a configuration for a set of resources comprising a plurality of resource occasions for one or more wake-up request messages and for one or more wake-up acknowledgement messages, the configuration being based at least in part on an energy profile of a user equipment (UE);
transmit, to the UE, a wake-up request message during a first resource occasion of the plurality of resource occasions in accordance with the configuration; and
receive, in response to the wake-up request message, a wake-up acknowledgement message during a corresponding second resource occasion of the plurality of resource occasions in accordance with the configuration.

27-28. (canceled)

29. A method for wireless communication at a user equipment (UE), comprising: receiving an indication of a configuration for a set of resources comprising a plurality of resource occasions for one or more wake-up request messages and for one or more wake-up acknowledgement messages, the configuration being based at least in part on an energy profile of the UE;
receiving a wake-up request message during a first resource occasion of the plurality of resource occasions in accordance with the configuration; and
transmitting, in response to the wake-up request message, a wake-up acknowledgement message during a corresponding second resource occasion of the plurality of resource occasions in accordance with the configuration.

30. (canceled)
